(19) United States
(12) Patent Application Publication
(10) Pub. No.: US 2014/0250801 A1
(43) Pub. Date: Sep. 11, 2014

(54) KIT AND COMPONENTS FOR A FLASHING INSTALLATION

(71) Applicant: Chris Knollmeyer, Lincoln, MA (US)

(72) Inventor: Chris Knollmeyer, Lincoln, MA (US)

(21) Appl. No.: 13/790,027

(22) Filed: Mar. 8, 2013

(51) Int. Cl. E06B 1/36

(52) U.S. Cl. CPC E06B 1/36
USPC 52/58

(57) ABSTRACT

The present disclosure relates to components for properly waterproofing sections of a building and a flashing kit including the components with installation instructions. Such components may include lower corner flashings constructed to be engaged with an elongated lower flashing and installed, e.g., at a sill. In some embodiments, an elongated lower flashing may be attached to lower corner flashings by a rear hooked arrangement. Flashing components may include upper end cap flashings for placement on appropriate ends of an upper trim board. Upper end cap flashings may have side plate portions constructed to cover respective side facing portions of the upper trim. An elongated upper flashing may be placed on respective upper end cap flashings. Components presented herein may be appropriate for directing water from flowing and accumulating into sensitive areas of a building that would otherwise lead to water damage.

### BACKGROUND

1. Field

Flashing and methods for installing the flashing are generally described. A kit including flashing appropriate for protecting a region of a building structure from water damage is also described.

2. Discussion of Related Art

One of the most common reasons buildings (commercial, residential) or other similar structures are in need of repairs is due to the occurrence of water damage. Intrusion of water into certain areas of buildings creates an environment that may lead to the development of mold, rot and/or decay, which may be difficult, if not impossible, to correct without replacement of key structural components. Accordingly, regions of building structures that may be prone to leakage, such as at the frames of openings (e.g., for doors, windows, glazings), must be properly sealed; otherwise, water may undesirably collect in sensitive areas and give rise to damage. To prevent or minimize such water leakage and/or collection, these regions of a building should be flashed.

Flashing components may include thin strips of sheet metal or other protective material(s) that are impervious to water. Such material may serve as a barrier or seal for obstructing the passage of water through areas of an opening or a frame of an opening in a building. In accordance with existing practices in the field of construction, those of skill in the art are typically faced with the decision to choose one of two completely different types of flashing materials, either 1) a membrane (e.g., self-adhering rubber/elastomer, polymer); or 2) a rigid component, such as a strip of plastic (e.g., rigid polymer) or metal (e.g., aluminum, copper, painted galvanized steel, stainless steel, zinc alloy). Such flashing materials are often placed around the edges of the frame of an opening in a building.

However, more often than not, openings of buildings are not flashed properly. It is typical for certain areas of an opening, such as at an angled region, corner or joint, to be insufficiently sealed because it is inconvenient, difficult or, given the materials available, not possible for workers to seal those areas. For instance, while a flashing component may extend along a substantial portion of the frame of an opening of a building (e.g., head, sill and jamb regions of a window or glazing), certain transition regions such as corners or crevices between support boards may allow water to leak into sensitive areas of the opening and detrimentally accumulate. Or worse yet, the opening might not be flashed at all, increasing the chances for the occurrence of water damage.

### SUMMARY

The inventor has recognized that it may be advantageous to provide a flashing kit that includes appropriate components together with instructions for providing proper waterproofing (i.e., preventing leakage and accumulation of water) in particular sections of a building. Such sections of a building to which the flashing components may be installed include windows, glazings, doors, or other areas. The components provided with the kit may include a number of protective strips (e.g., relatively flexible membranes, self-adhering sealing membranes) and flashings (e.g., relatively rigid plated structures).

In some embodiments, the protective strips, which may be composed of a generally flexible material, may be placed at certain regions of the frame of an opening, such as at lower, side and upper regions (e.g., sill, jambs, head) of a window or a door. In some embodiments, the flashings may be relatively rigid in construction and may also be placed at certain regions of the frame of the opening, for example, covering respective lower and upper regions (e.g., sill, head) of a window or door. Protective strips and flashings may have suitable dimensions and characteristics that are appropriate for the particular section or opening of the building being waterproofed.

One type of flashing may be a lower corner flashing. A lower corner flashing may be constructed to be placed at a lower corner (e.g., sill corner) of a frame of an opening and may have a number of plate portions. For example, a lower corner flashing may have a rear plate portion that extends substantially parallel to a plane defined by the frame of the opening. The rear plate portion may also extend along a rear portion of the frame. The lower corner flashing may also have a side plate portion that may be placed generally flush against a side region (e.g., jamb) of the frame. The lower corner flashing may have a front plate portion that covers part of the front surface of the frame or building.

Another type of flashing may be an elongated lower flashing. An elongated lower flashing may be constructed for placement in a position where the elongated lower flashing is engaged with respective lower corner flashings which are appropriately placed and located opposite one another. In some embodiments, a portion of the elongated lower flashing may be shaped (e.g., to include a hook) so as to engage with one or more respective rear plate portions of lower corner flashings. Once engaged, such a configuration may provide continuity in a flashing installation at a lower region of a frame (e.g., sill) that allows for a suitable obstruction to water leakage and/or re-direction of flow that may otherwise lead to accelerated water damage.

A different type of flashing may be an upper end cap flashing. An upper end cap flashing may be constructed for placement on an appropriate end at an upper region (e.g., an upper/head trim board) of a frame of an opening in a building. The upper end cap flashing may have a number of plate portions that extend, at least partially, along the upper region of the frame of the opening. For instance, an upper end cap flashing may have a side plate portion that is constructed to cover a side facing portion of the upper region of the frame of the opening. In some embodiments, the upper region of the frame on which the upper end cap flashing is placed may be an upper/head trim board of a window or door frame. The upper end cap flashing may also include an upward facing plate portion having a surface that is maintained to be sloped downward toward the front of the frame or building (i.e., sloped downward toward a front plate portion). Accordingly, once installed, upper end cap flashings may be suitable for directing water flow in a manner that significantly reduces opportunity for water damage to occur.

Yet another type of flashing may be an elongated upper flashing. An elongated upper flashing may be constructed for placement on, and/or engagement with, respective upper end cap flashings situated appropriately on opposing ends of an upper region of the frame (e.g., head region). In some embodiments, once upper end cap flashings are placed respectively on ends of a trim board of an upper region of a window or door, an elongated upper flashing may be placed on the upper end cap flashings and, thus, connecting them together. As a result, the combined unit of the elongated upper flashing and the upper end cap flashings may effectively divert water from flowing into sensitive areas that would otherwise be likely to cause water damage.

In an illustrative embodiment, a kit including instructions for installing flashing components on a frame for protecting a building structure is provided. The kit includes at least one protective strip constructed to be placed at a lower region of the frame; at least one lower flashing constructed to be placed at the lower region of the frame; at least one protective strip constructed to be placed at a side region of the frame; at least one protective strip constructed to be placed at an upper region of the frame; at least one upper flashing constructed to be placed at the upper region of the frame; and a container for holding each of the at least one protective strip constructed to be placed at the lower region, the side region and the upper region of the frame, the at least one lower flashing, and the at least one upper flashing.

In another illustrative embodiment, a component for placement at a lower region of a frame providing protection for a building structure is provided. The component includes a lower corner flashing including a rear plate portion constructed to extend along a rear portion of the lower region of the frame and substantially parallel to a plane defined by the frame, the rear plate portion further constructed to engage with a portion of an elongated lower flashing so as to limit movement between the lower corner flashing and the elongated lower flashing.

In a different illustrative embodiment, a component for placement at an upper region of a frame providing protection for a building structure is provided. The component includes an upper end cap flashing including: an upward facing plate portion having a surface maintained to be sloped downward toward a front of the frame and constructed to cover an end of an upward facing portion of the upper region of the frame; and a side plate portion constructed to cover a side facing portion of the upper region of the frame.

In yet another illustrative embodiment, a method of installing flashing components on a lower region of a frame for protecting a building structure is provided. The method includes placing a first lower corner flashing at a first corner of the lower region of the frame so that an upward facing plate portion of the first lower corner flashing is sloped downward toward a front of the frame, the first lower corner flashing including a rear plate portion that extends along a rear portion of the lower region of the frame and substantially parallel to a plane defined by the frame; placing a second lower corner flashing at a second corner of the lower region of the frame so that an upward facing plate portion of the second lower corner flashing is sloped downward toward a front of the frame, the second lower corner flashing including a rear plate portion that extends along a rear portion of the lower region of the frame and substantially parallel to the plane defined by the frame; and engaging an elongated lower flashing with each of the rear plate portions of the first and second lower corner flashings so as to connect the first and second lower corner flashings together.

In an illustrative embodiment, a method of installing flashing components on an upper region of a frame for protecting a building structure is provided. The method includes placing a first upper end cap flashing at a first end of the upper region of the frame so that an upward facing plate portion of the first upper end cap flashing is sloped downward toward a front of the frame and a side plate portion of the first upper end cap flashing covers a first side facing portion of the upper region of the frame; placing a second upper end cap flashing at a second end of the upper region of the frame so that an upward facing plate portion of the second upper end cap flashing is sloped downward toward a front of the frame and a side plate portion of the second upper end cap flashing covers a second side facing portion of the upper region of the frame; and placing an elongated upper flashing on each of the upward facing plate portions of the first and second upper end cap flashings.

In another illustrative embodiment, a kit including instructions for installing flashing components on a lower region of a frame for protecting a building structure is provided. The kit includes at least one protective strip constructed to be placed at the lower region of the frame; a first lower corner flashing constructed to be placed at a first corner of the lower region of the frame; a second lower corner flashing constructed to be placed at a second corner of the lower region of the frame; an elongated lower flashing constructed to engage with each of the first and second lower corner flashings; and a container for holding the first lower corner flashing, the second lower corner flashing, and the elongated lower flashing.

In yet another illustrative embodiment, a kit including instructions for installing flashing components on an upper region of a frame for protecting a building structure is provided. The kit includes at least one protective strip constructed to be placed at the upper region of the frame; a first upper end cap flashing constructed to be placed at a first upper region of the frame; a second upper end cap flashing constructed to be placed at a second upper region of the frame on an end opposite the first upper region of the frame; an elongated upper flashing constructed to be placed on the first and second upper end cap flashings; and a container for holding the first upper end cap flashing, the second upper end cap flashing, and the elongated upper flashing.

In a different illustrative embodiment, a flashed assembly of a lower region of a frame for protecting a building structure is provided. The flashed assembly includes a first lower corner flashing located at a first corner of the lower region of the frame so that an upward facing plate portion of the first lower corner flashing is sloped downward toward a front of the frame, the first lower corner flashing including a rear plate portion that extends along a rear portion of the lower region of the frame and substantially parallel to a plane defined by the frame; a second lower corner flashing located at a second corner of the lower region of the frame so that an upward facing plate portion of the second lower corner flashing is sloped downward toward the front of the frame, the second lower corner flashing including a rear plate portion that extends along a rear portion of the lower region of the frame and substantially parallel to the plane defined by the frame; and an elongated lower flashing engaged with each of the rear plate portions of the first and second lower corner flashings and connecting the first and second lower corner flashings together.

In yet another illustrative embodiment, a flashed assembly of an upper region of a frame for protecting a building structure is provided. The flashed assembly includes a first upper end cap flashing located at a first end of the upper region of the frame so that an upward facing plate portion of the first upper end cap flashing is sloped downward toward a front of the frame and a side plate portion of the first upper end cap flashing covers a first side facing portion of the upper region of the frame; a second upper end cap flashing located at a second end of the upper region of the frame so that an upward facing plate portion of the second upper end cap flashing is sloped downward toward the front of the frame and a side plate portion of the second upper end cap flashing covers a second side facing portion of the upper region of the frame; and an elongated upper end cap flashing disposed on each of the upward facing plate portions of the first and second upper end cap flashings.

Advantages, novel features, and objects of the invention will become apparent from the following detailed description of the invention when considered in conjunction with the accompanying drawings, which are schematic and which are not intended to be drawn to scale. For purposes of clarity, not every component is labeled in every figure, nor is every component of each embodiment of the invention shown where illustration is not necessary to allow those of ordinary skill in the art to understand the invention.

### BRIEF DESCRIPTION OF THE DRAWINGS

The accompanying drawings are not intended to be drawn to scale. In the drawings, each identical or nearly identical component that is illustrated in various figures is represented by a like numeral. Various embodiments of the invention will now be described, by way of example, with reference to the accompanying drawings, in which:

FIG. 1A shows a portion of a frame of an opening in accordance with some embodiments;

FIG. 1B depicts an installation in the frame of the opening of FIG. 1A;

FIG. 2 illustrates components for a kit in accordance with some embodiments;

FIG. 3A shows a container for a kit including components in accordance with some embodiments;

FIG. 3B depicts a side view of the container of FIG. 3A;

FIG. 4 illustrates a perspective view of an upper corner flashing in accordance with some embodiments;

FIG. 5A shows a perspective view of a lower corner flashing in accordance with some embodiments;

FIG. 5B shows a perspective view of another lower corner flashing in accordance with some embodiments;

FIG. 6 depicts a schematic of an upper corner flashing and a lower corner flashing placed on portions of a frame in accordance with some embodiments;

FIG. 6A shows an enlarged perspective view of the portion of FIG. 6 as identified by arrow 6A;

FIG. 6B is an enlarged perspective view of the portion of FIG. 6 as identified by arrow 6B;

FIG. 6C illustrates an alternative lower corner flashing placed on a lower corner of a frame in accordance with some embodiments;

FIG. 7 depicts an elongated lower flashing in accordance with some embodiments;

FIG. 8 shows a partial cut-away perspective view of an elongated lower flashing and a lower corner flashing placed on a lower region of a frame in accordance with some embodiments;

FIG. 9A illustrates a cross-sectional perspective view, cut at the region indicated by 9A in FIG. 8, through a section of a lower region of the frame;

FIG. 9B depicts a cross-sectional view, cut at the region indicated by 9B in FIG. 8, through a central portion of the lower region of the frame;

FIG. 10 illustrates a partial cut-away schematic of a protective side member placed on a side of a frame in accordance with some embodiments;

FIG. 11A shows a perspective view of an upper end cap flashing in accordance with some embodiments;

FIG. 11B depicts a perspective view of another upper end cap flashing in accordance with some embodiments;

FIG. 11C illustrates a cross-sectional view of the upper end cap flashing of FIG. 11B;

FIG. 12 illustrates a schematic of upper end cap flashings placed on opposing ends of an upper region of a frame in accordance with some embodiments;

FIG. 13 shows a partial view of an elongated upper flashing placed on an upper region of a frame in accordance with some embodiments;

FIG. 14 depicts a cross-sectional view of an elongated upper flashing placed on an upper region of a frame in accordance with some embodiments;

FIG. 15 depicts a perspective view of an upper intermediate flashing in accordance with some embodiments;

FIG. 16 shows a flow diagram of a method of installing components of a kit in accordance with some embodiments; and

FIGS. 17A-17I illustrate steps for installing components of a kit on a frame in accordance with some embodiments.

### DETAILED DESCRIPTION

The present disclosure relates to flashing of a section of a building (e.g., a section that includes a window, glazing, door, etc.) and components for providing the flashing. Such components may be held in a kit including instructions for installing the components. The components, when properly installed, may be suitable for directing water flow drainage at certain portions of a building that may otherwise be prone to leakage or water damage, such as where a window, glazing, door is located. As determined herein, a window may include a glazing or may itself be a glazing suitable for transmitting light.

Components of the kit may include a number of protective strips and flashings, amongst other articles for effectively waterproofing an opening. In some embodiments, protective strips may be relatively flexible and suitable for placement at certain regions of a frame of an opening in a building. As an example, when flashing a window frame of a building, protective strips may be appropriately installed at the window sill, the window jambs and the window head. In some cases, flashings may be relatively rigid, as compared with the protective strips, and may be constructed for placement at various regions of the frame in a manner that complements placement of the protective strips.

In some embodiments, after opening, certain components of the flashing kit may be further fitted or manipulated (e.g., cut, bent, formed, molded) so as to have dimensions that would be suitable for installing the component(s) at the appropriate region(s) of the building. Or, components of the kit may be pre-cut and/or sized prior to packaging so that no additional work is necessary to be performed on individual components upon opening of the kit and prior to installation. For instance, a kit may provide all of the components necessary to appropriately flash a frame for a standard sized window, glazing or door. Included with the kit are also step-by-step instructions that describe in detail how each component within the kit should be handled and installed with respect to the frame. Such instructions may be written and illustrated in accordance with methods described herein, in whole or in part, for suitably installing the components of the flashing kit.

The kit may have components suitable for flashing standard-sized windows, for example, up to 3 feet×5 feet with ¾ inch casings. Though, it can be appreciated that kits and components suitable for flashing any type of opening in a building, including standard or non-standard sized openings for residential and commercial building structures, are within the scope of the present disclosure.

The inventor has recognized that the materials necessary for properly waterproofing certain sections of a building (e.g., frames where a window, glazing, door are located) are not readily available for use in one place or package and certainly not in the form of a kit, as described herein. For instance, the combination of protective strips and flashings in a single place that are fitted and sized (e.g., cut, bent, molded, formed) to have appropriate dimensions and features for flashing standard or non-standard sized openings of a building, in whole or in part, had not previously been available. In fact, one of ordinary skill in the construction industry is unlikely to seek to combine multiple components from independent sources to waterproof an opening, for example, due to limited amounts of space available at the target site(s) for installation of flashing—the more material is included in the frame, the more difficult it may be to install the window itself and/or other components. Accordingly, due to the unavailability of such a kit, it would be impractical for a skilled artisan to assess: 1) which materials to use, 2) where to obtain such materials, and 3) how to use them in combination. The inventor has appreciated that it would be beneficial to provide such a kit complete with unique components so that a worker would have all of the components necessary to properly flash a section of a building, and would also have detailed instructions for suitably installing the components.

For appropriately flashing a lower region of an opening (e.g., sill of a window, door), in some embodiments, the kit may include two lower corner flashings each constructed to be placed at respective corners of the lower region of the frame of the opening. The kit may also include an elongated lower flashing that is constructed to engage with and connect each of the lower corner flashings together, to form a continuous unit for suitably directing water flow. Though, in some embodiments, the kit includes a single monolithic unit equivalent to the elongated lower flashing and the two lower corner flashings all joined together as one.

To suitably flash an upper region of an opening (e.g., upper/head trim board of a window or door), in some embodiments, the kit may include two upper end cap flashings each constructed to be placed at opposite ends of an upper region of the frame (e.g., outer corners of the top of a trim board) of the opening. As an example, upper end cap flashings may cover appropriate upward facing and side facing portions of the trim of a window head. The kit may also include an elongated upper flashing constructed to be placed over each of the upper end cap flashings, forming a continuous unit for appropriately directing water flow. Similar to that described for the lower flashings, in some embodiments, the kit may include a single monolithic unit equivalent to the elongated upper flashing and the two upper end cap flashings joined together.

Each of the upper end cap flashings and the elongated upper flashing may also be constructed to maintain a downward slope in a direction toward the front of the opening so that, when such flashings are appropriately installed, water is directed along the surface of the flashings toward the front of the opening. This is in contrast to conventional flashing components that, upon transit and installation, are often bent backwards so as to form a trough into which water will collect and flow out and off the side ends.

As determined herein, when referring to a section of a building (e.g., an opening), the front of the section corresponds to a region located toward the outside of the building. Accordingly, the rear of a section of a building corresponds to a region located toward the inside of the building.

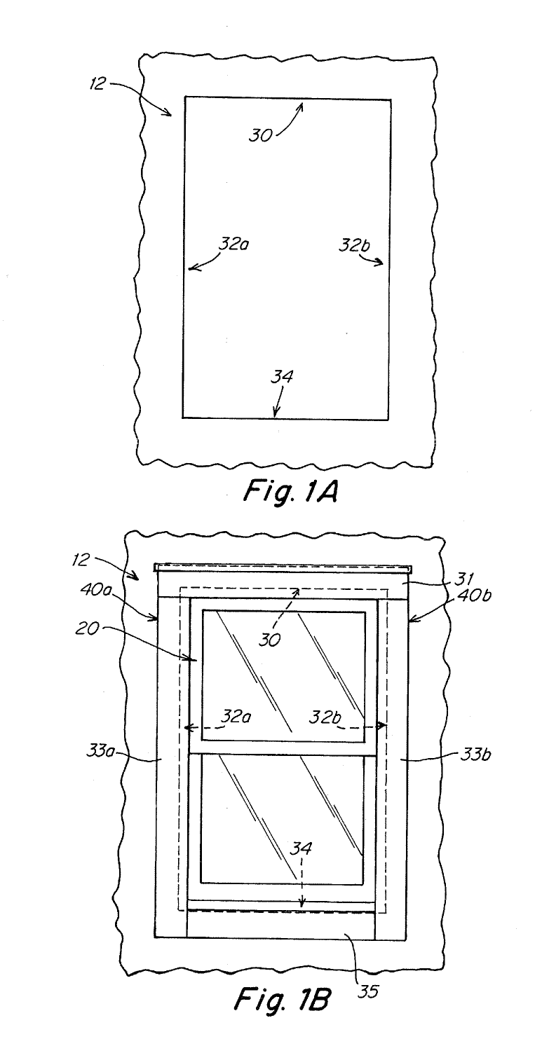

FIG. 1A depicts a portion of a frame 12 of an opening, the frame having an upper region 30, side regions 32a, 32b, and a lower region 34. For a window/door opening, these regions correspond to a window/door head 30, window/door jambs 32a, 32b, and a window/door sill 34. FIG. 1B includes a trim, including an upper trim board 31, side trim boards 33a, 33b and a lower trim board 35. Various portions of a trim board may be side facing with respect to the frame. For instance, side trim boards 33a, 33b that extend from the upper region 30 to the lower region 34 of the frame 12 may include side facing portions 40a, 40b. An entry member 20 (e.g., window glass, glazing, door) of the opening is installed within the frame of the opening. In some embodiments, when installed, the trim is located in front relative to the entry member.

As discussed above, prior to the inventor's conception of that presented herein, those skilled in the art had failed to recognize that it would be advantageous to collect different components available from independent and separate sources, as well as unique components not previously available, and place them together as a combination in a kit. Such a kit provides a pre-arranged set of components allowing for flashing of an opening in a building to be easily performed.

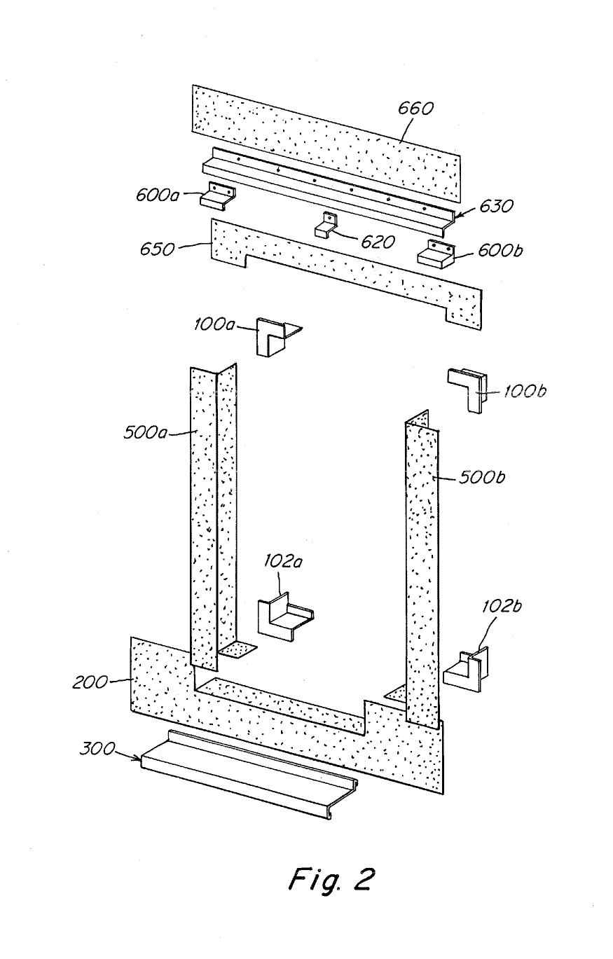

FIG. 2 depicts various parts that may be available in such a kit while also including instructions for installing the flashing components on a frame of an opening of a building. In this embodiment, the kit includes lower corner flashings 102a, 102b, an elongated lower flashing 300 and a protective strip 200. These components may be appropriate for flashing installation at a lower/sill region of the frame (e.g., window sill). The kit may also include protective strips 500a, 500b that may be placed at respective side regions of the frame (e.g., window jambs). For flashing installation on the upper region of the frame (e.g., upper trim board of a window head), the kit may alternatively, or in addition, include upper corner flashings 100a, 100b, upper end cap flashings 600a, 600b, an elongated upper flashing 630 and protective strips 650, 660. Upper corner flashings 100a, 100b may be placed at respective corners of the frame of the opening. Upper end cap flashings 600a, 600b may be placed, for example, on an upper/head trim board of the frame. In some cases, an upper intermediate flashing 620 may be appropriate for flashing of openings where the upper region of the frame (e.g., upper/head trim board) is quite long. While not expressly shown in the figures, other components (e.g., fasteners, additional protective strips or flashings, instructions, etc.) may also be included in the kit. It can also be appreciated that the kit may include any one of the components discussed above and does not require each and every one of the components mentioned.

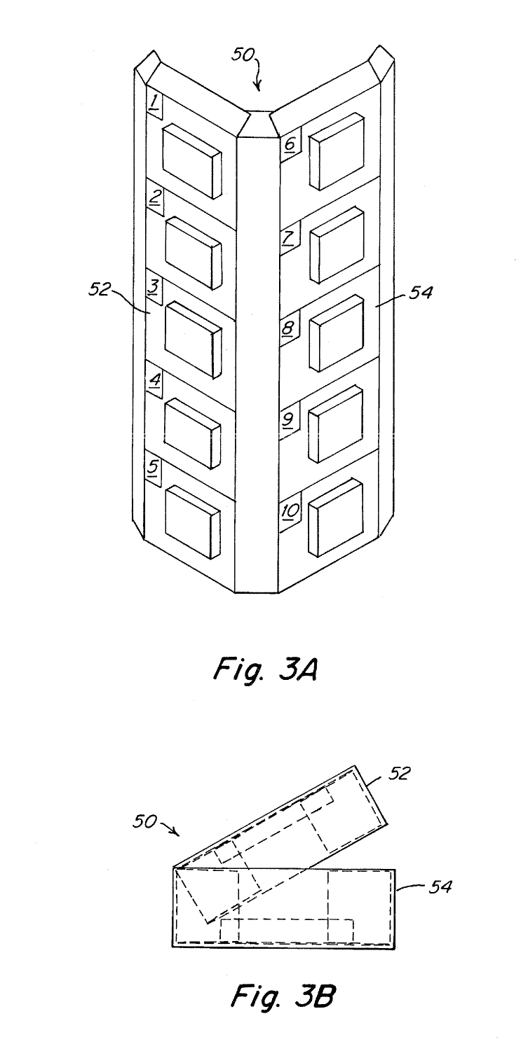

The kit may include a container 50 for placement of each of the above-mentioned flashing components. FIGS. 3A-3B illustrate a container 50 for a kit including flashing components and detailed instructions for installing the flashing. The container 50 may, for example, be a box that includes a cover 52 and a base 54 on which the instructions are provided. As shown in FIG. 3A, for an embodiment, step-by-step instructions are numbered from 1 to 10 and provide clear details and illustrations for installing each of the protective strips and flashings. The instructions may be based, at least in part, on methods for installing components of the flashing kit presented herein.

In some embodiments, the container may include blister-type packaging or any other suitable compartment style package. Such compartments may have any suitable dimensions for holding the components of the kit.

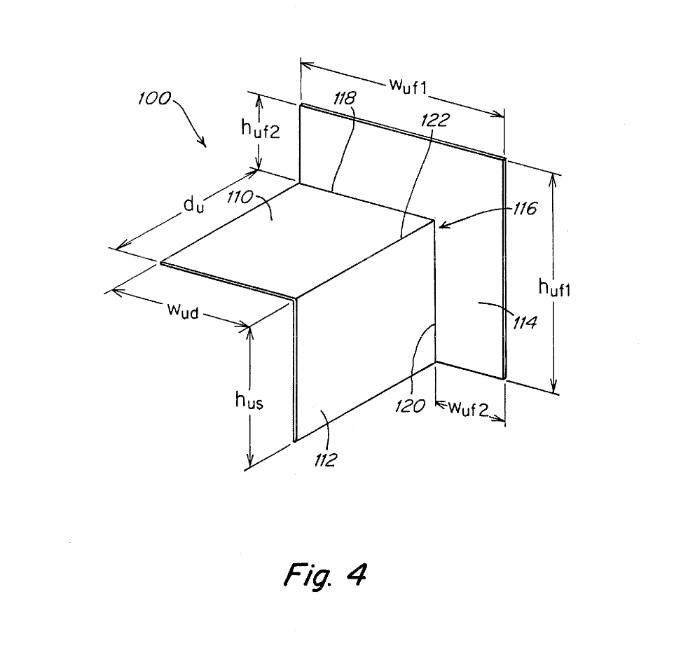

FIG. 4 shows an illustrative embodiment of an upper corner flashing 100 (e.g., for placement at a corner of a window head), which has a number of plate portions. In some embodiments, the upper corner flashing 100 includes a downward facing plate portion 110, a side plate portion 112 and a front plate portion 114 (i.e., flange). The upper corner flashing may be appropriately bent or formed at certain locations in a manner so as to give rise to a number of upper corner plate edges 116, for instance, an edge 118 formed by an intersection between the downward facing plate portion 110 and the front plate portion 114; an edge 120 of the intersection between the side plate portion 112 and the front plate portion 114; and an edge 122 of the intersection between the downward facing plate portion 110 and the side plate portion 112. Such edges generally run parallel to corresponding edges of the corner of the frame of the opening. Edges of the flashing may be beneficial because conventional flashing materials generally do not come pre-bent, molded or formed so as to have structural features and dimensions for appropriately directing or obstructing water flow in and around the frame of the opening in a desired manner.

Various portions of the upper corner flashing 100 may have dimensions suitable for flashing the frame of the opening (e.g., a standard window opening). As depicted in FIG. 4, dimensions of the upper corner flashing 100 may include, for example, the depth dᵤ of the upper corner flashing, a first width w_{uf1} and a second width w_{uf2} of the front plate portion, a first height h_{uf1} and a second height h_{hf2} of the front plate portion, a width w_{ud} of the downward facing plate portion, and a height hᵤₛ of the side plate portion. Such dimensions may vary appropriately depending on the particular opening/area of the building to be treated or flashed.

The depth dᵤ of the upper corner flashing may be determined based on the depth of the opening of the frame itself, that is, the distance between a front edge and a rear edge of the opening. That is, the depth dᵤ may be long enough so that the upper corner flashing appropriately covers an underside at the upper corner(s) of the frame extending between the front and rear edges of the opening. Standard window openings may, for example, be 3.5 inches, 4 inches, 5 inches, 5.5 inches, or 6 inches deep. Accordingly, in some embodiments, the depth dᵤ of the upper corner flashing may be between about 1 inch and about 12 inches, between about 2 inches and about 10 inches, between about 3 inches and about 6 inches, between about 5 inches and about 8 inches (e.g., 5.5 inches, 6 inches), between about 2 inches and about 5 inches, or between about 3 inches and about 4 inches (e.g., 3.5 inches, 4 inches). In some embodiments, the depth dᵤ of the upper corner varies outside of these dimension ranges.

The first and second widths w_{uf1}, w_{uf2} and the first and second heights h_{uf1} of the front plate portion may vary appropriately depending on the amount of flange coverage desired from the edge(s) of the opening along the front of the upper region (e.g., window head) of the frame.

In some embodiments, the first width w_{uf1} and the first height h_{uf1} of the front plate portion may be between about 1 inch and about 10 inches, between about 3 inches and about 8 inches, or between about 4 inches and about 6 inches (e.g., 5 inches). In some cases, the first width w_{uf1} and the first height h_{uf1} of the front plate portion may be approximately the same in length as the depth dᵤ of the upper corner flashing. Though, it can be appreciated that the first width w_{uf1} and the first height h_{uf1} of the front plate portion may have different dimensions, as well as different dimensions from the depth dᵤ.

In some embodiments, the second width w_{uf2} and the second height h_{uf2} of the front plate portion may be between about 0.5 inches and about 5 inches, between about 1 inch and about 4 inches, or between about 1.5 inches and about 3 inches (e.g., 2 inches). In some cases, the second width w_{uf2} and the second height h_{uf2} of the front plate portion may be less than the depth dᵤ of the upper corner flashing (e.g., about half of the length of depth dᵤ). The second width w_{uf2} and the second height h_{uf2} of the front plate portion may have dimensions that differ from one another.

The width w_{ud} of the downward facing plate portion and the height hᵤₛ of the side plate portion may vary according to the amount of coverage of the underside and the side of the corner of the frame desired directly from the corner. In addition, it may be preferred that a protective strip (e.g., membrane flashing component) such as strip 650 and/or strips 500a, 500b overlaps the upper corner flashing 100 by a suitable distance (e.g., at least 3 inches) so as to provide an appropriate seal for the flashing. Accordingly, the width w^{ud} of the downward facing plate portion and the height hᵤₛ of the side plate portion is long enough to provide the desired overlap between the protective strip(s) and the upper corner flashing. In some embodiments, the width w_{ud} of the downward facing plate portion and the height hᵤₛ of the side plate portion may be between about 1 inch and about 10 inches, between about 2 inches and about 7 inches, or between about 2 inches and about 4 inches (e.g., 3 inches). While the width w_{ud} of the downward facing plate portion and the height hᵤₛ of the side plate portion are shown to be approximately equal, these dimensions may differ appropriately.

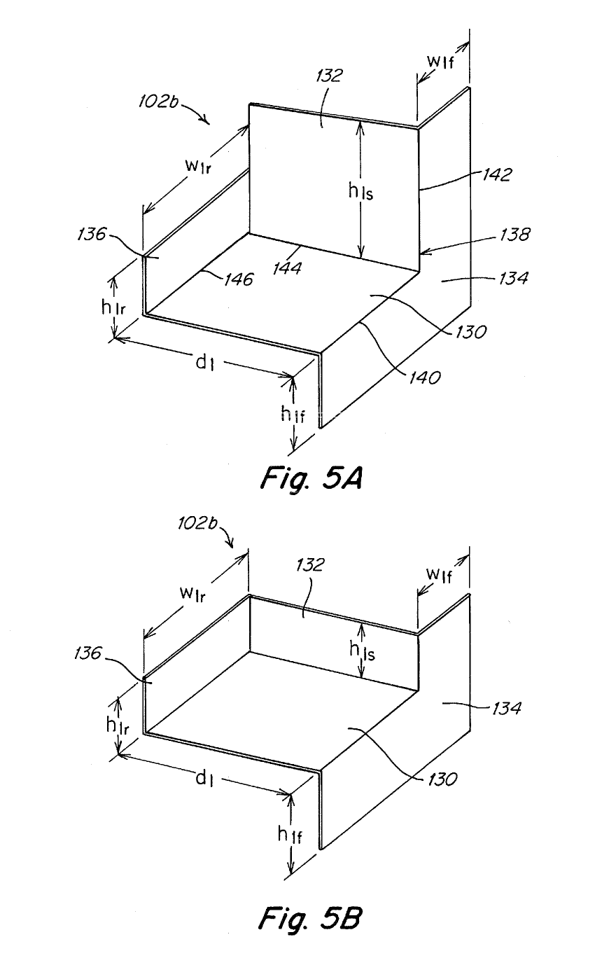

FIGS. 5A and 5B illustrate various embodiments of a lower corner flashing 102 (e.g., for placement at a corner of a window sill). The lower corner flashing 102 may have an upward facing plate portion 130, a side plate portion 132, a front plate portion 134 and a rear plate portion 136. Similar to the upper corner flashing, the lower corner flashing may be appropriately bent, molded, or otherwise formed so as to include a number of lower corner plate edges 138 defined by intersections between plate portions. Such edges may be, for example, an edge 140 of the intersection between the upward facing plate portion 130 and the front plate portion 134; an edge 142 provided by the intersection between the side plate portion 132 and the front plate portion 134; an edge 144 of the intersection between the upward facing plate portion 130 and the side plate portion 132; and an edge 146 of the intersection between the upward facing plate portion 130 and the rear plate portion 136. Lower corner flashings may be provided (e.g., in a pre-bent or molded configuration) in a kit where each of the flashings have dimensions appropriate for flashing an opening of a building.

As discussed, various embodiments of flashing components described herein may be installed at certain sections of buildings other than windows, for example, doors. In such cases, structural configurations of the flashing components may vary depending on where the flashing is to be installed. For instance, flashing components suitable for installation at a lower region of a door (e.g., door sill) may have similarities to the lower corner flashings of FIGS. 5A and 5B. Though, when installing appropriate flashing for a door, because doors are often not elevated above a floor in the manner that a window would typically be, in some cases, a lower corner flashing may have a front plate portion that does not extend, or extends only a short distance, below the upward facing plate portion.

Certain portions of the lower corner flashing 102 (e.g., sill corner flashing) may have dimensions appropriate for flashing the frame of the opening (e.g., a standard window opening). Lower corner flashings shown in FIGS. 5A and 5B have a number of dimensions, such as the depth dₗ of the lower corner flashing, a width w_{if} of the front plate portion, a height h_{lf} of the front plate portion, a height hₗₛ of the side plate portion, a width wₗᵣ of the rear to plate portion, and a height hₗᵣ of the rear plate portion.

Similar to the depth of the upper corner flashings, the depth dₗ of the lower corner flashing may be determined based on the distance between a front edge and a rear edge of the opening, so that the lower corner flashing suitably covers an upper side at the lower corner(s) of the frame. For example, a window sill may have a 2 inch×4 inch (e.g., actual 1.5 inches×3.5 inches) construction, where the distance between front and rear edges between approximately 3-4 inches (e.g., 3.5 inches), or a 2 inch×6 inch (e.g., actual 1.5 inches×5.5 inches) construction, where the distance between front and rear edges between approximately 5-6 inches (e.g., 5.5 inches). Though, of course, flashing dimensions to suit other constructions are possible. In some embodiments, the depth dₗ of the lower corner flashing may be between about 1 inch and about 12 inches, between about 2 inches and about 10 inches, between about 5 inches and about 8 inches (e.g., 5.5 inches, 6 inches, 6 and 9/16 inches), between about 3 inches and about 6 inches, or between about 4 inches and about 6 inches (e.g., 4 and 9/16 inches).

The width w_{lf} and the height h_{lf} of the front plate portion may vary appropriately depending on the desired degree of flange coverage from the front edge of the opening along the front of the lower region (e.g., window sill) of the frame. In some cases, the width w_{lf} and the height h_{lf} or the front plate portion may be less than the depth dₗ of the lower corner flashing (e.g., about half of the length of depth dₗ). In some embodiments, the width w_{lf} and the height h_{lf} of the front plate portion may be between about 0.5 inches and about 5 inches, between about 1 inch and about 4 inches, between about 1.5 inches and about 3 inches (e.g., 2 inches). In some cases, the width w_{lf} and the height h_{lf} of the front plate portion may have different dimensions.

In some embodiments, as shown in FIG. 5A, the height hₗₛ of the side plate portion may extend past the height hₗᵣ of the rear plate portion (e.g., as an upturned leg). The height hₗₛ of the side plate portion may be long enough to provide a desired overlap between a protective strip, for example, that extends down the window jambs and covers an adequate portion of the lower corner flashing, at least, to provide an appropriate seal for the flashing.

For example, the height hᵢₛ of the side plate portion may be between about 1 inch and about 10 inches, between about 1.5 inches and about 7 inches, between about 1 inch and about 5 inches, or between about 2 inches and about 4 inches (e.g., 3 inches). In this respect, when installed, the additional height may provide additional support and/or waterproofing that extends up the side of the frame from the lower corner.

Or, in other embodiments, the height hₗₛ of the side plate portion may be about equal to the height hₗᵣ of the rear plate portion, as shown in FIG. 5B. For instance, the height hₗₛ of the side plate portion and the height hₗᵣ of the rear plate portion may be between about 0.5 inches and about 10 inches, between about 0.5 inches and about 5 inches, between about 0.5 inches and about 3 inches, between about 1 inch and about 5 inches (e.g., 3 inches), or between about 1 inch and about 3 inches (e.g., 1.5 inches). While lower corner flashings having a height hₗₛ of the side plate portion that is equal to the height hₗᵣ of the rear plate portion may be relatively compact, due to added support and sealing capabilities, lower corner flashings having a height hₗₛ of the side plate portion greater than the height hₗᵣ of the rear plate portion may be comparatively more effective in preventing water leakage and eventual water damage.

As discussed further below, lower corner flashings may be suitably structured so as to engage with an elongated lower flashing. Accordingly, the width wₗᵣ of the rear plate portion and the height hₗᵣ of the rear plate portion may each be of an appropriate length so as to be able to suitably and stably engage with the elongated lower flashing 300. In some embodiments, the width wₗᵣ of the rear plate portion may be between about 1 inch and about 10 inches, between about 2 inches and about 7 inches, between about 2 inches and about 5 inches, or between about 3 inches and about 5 inches (e.g., 4 inches).

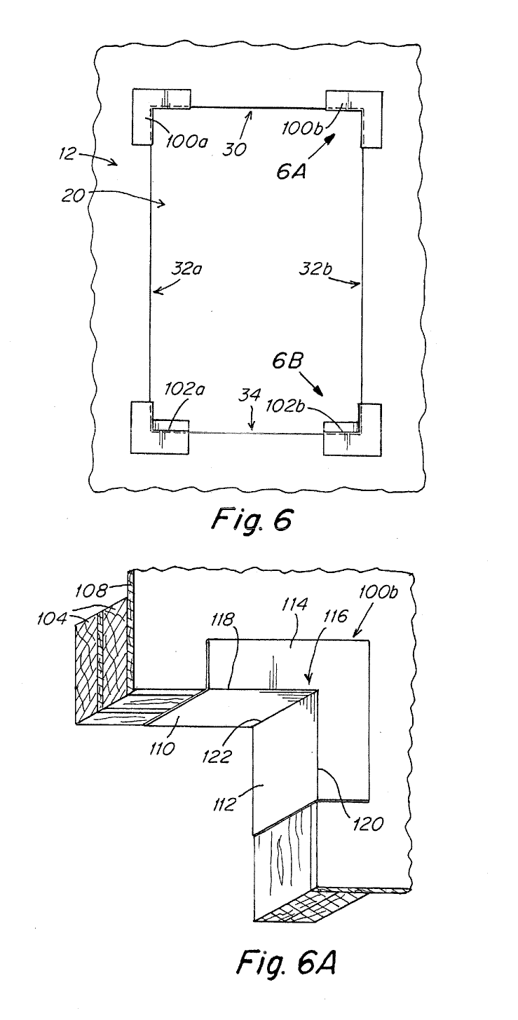

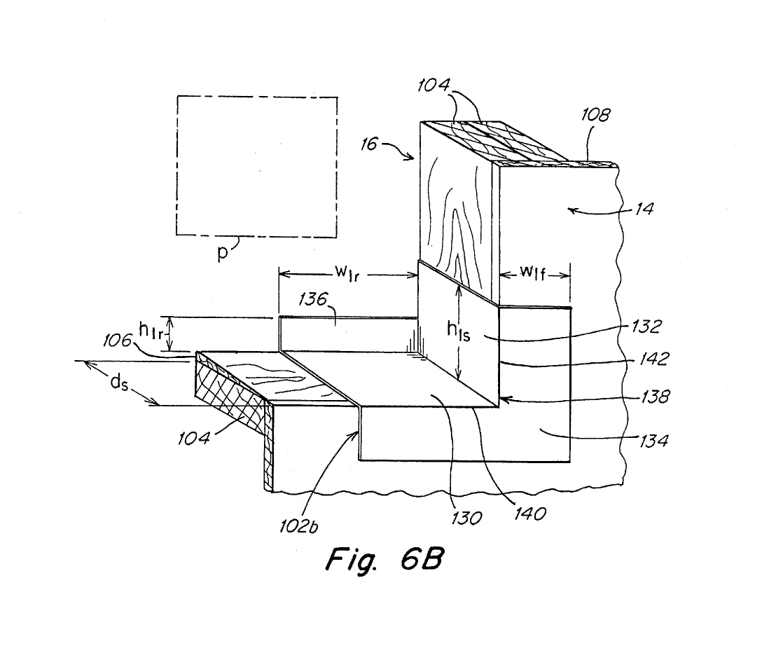

During installation, upper corner flashings and lower corner flashings are placed at respective corners of a frame (e.g., inner surfaces of the corners of a window/door frame). FIG. 6 depicts an illustrative embodiment where upper corner flashings 100a, 100b are placed at respective corners of an upper region 30 of a frame 12 of an opening, and lower corner flashings 102a, 102b are situated at opposing corners on a lower region 34 of the frame. In various embodiments, upper corner flashings 100a, 100b and lower corner flashings 102a, 102b are appropriately attached (e.g., adhered, fastened) to respective corners of the frame. For the sake of simplicity, house wrap material, which may be provided as appropriate, is not shown in FIG. 6. Upper and lower corner flashings may be attached to corners of the frame in any suitable manner. For instance, the flashings may be adhesively attached, or attached through an appropriate fastening device.

FIG. 6A depicts a close-up view of upper corner flashing 100b installed at an upper corner of the frame 12. FIGS. 6B and 6C show close-up views of different embodiments of lower corner flashings installed at various lower corners of a frame. In an embodiment of the lower corner flashing shown in FIG. 6B, the height hₗₛ of the side plate portion is greater than the height hₗᵣ of the rear plate portion. In the embodiment of the lower corner flashing of FIG. 6C, the height of the side plate portion is about equal to the height of the rear plate portion.

As shown in FIG. 6B, the front 14 of the frame is the region located toward the outside of the building and the rear 16 of the frame is the region located toward the inside of the building. Accordingly, the front plate portion 134 covers a front portion of a lower region of the frame and the rear plate portion 136 extends along a rear portion of the lower region of the frame. Both the front plate portion 134 and the rear plate portion 136 run substantially parallel to a plane p defined by the frame. As discussed, the rear plate portion 136 may be suitably structured to stably engage with an elongated lower flashing 300 in a manner that limits movement between the lower corner flashing and the elongated lower flashing 300 (e.g., limiting movement in a direction perpendicular to a plane p defined by the frame, such as from front to rear, and vice versa). Such a connection forms a seal so as to obstruct water from flowing into the building and accumulating in sensitive areas in and around the frame.

The upward facing plate portion 130 and the side plate portion 132 extend in directions that are substantially perpendicular to the plane p defined by the frame. As further shown in FIGS. 6B and 6C, when the lower corner flashing 102 is installed, the upward facing plate portion 130 covers an upper facing side of the lower region of the frame (e.g., upper surface of a window sill that runs horizontally) and is sloped downward toward the front 14 of the frame. To induce and maintain a slope of the upward facing plate portion 130 toward the front of the frame and/or the building exterior, a wedged member 106 (e.g., clapboard) may be placed on the upper facing side of the lower region of the frame prior to installation of the lower corner flashings. This slope toward the front of the frame encourages flow of water and drainage toward the outside of the opening.

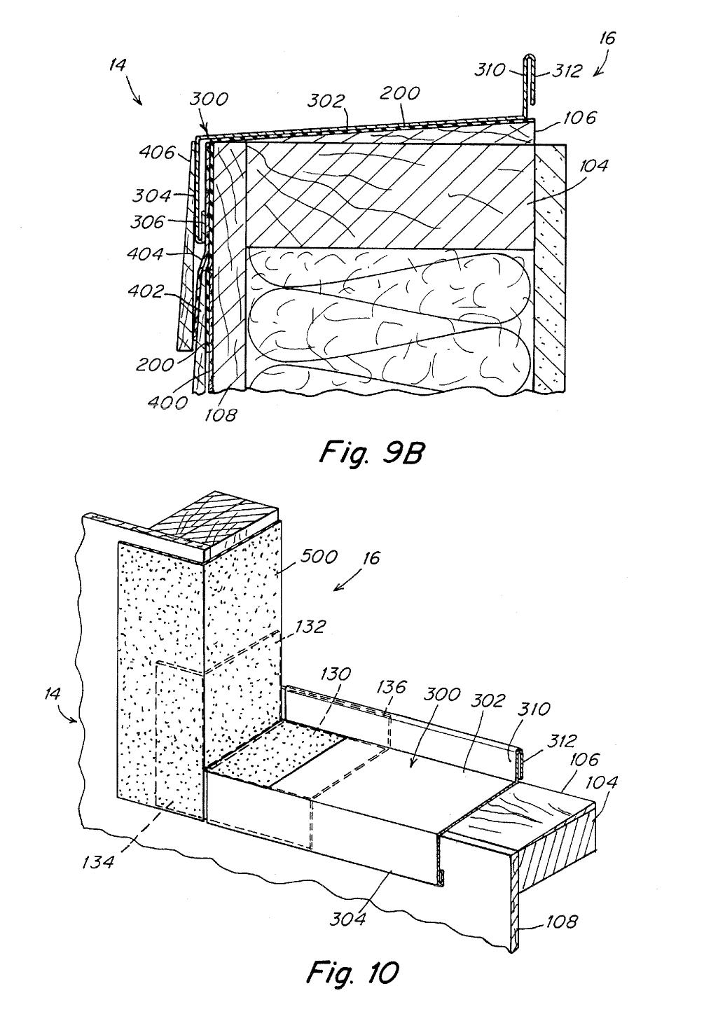

Optionally, a flexible protective strip (e.g., self-adhering membrane) (not shown in FIGS. 6B and 6C, but shown in FIGS. 9A and 9B) may be included between the wedged member 106 and the upward facing plate portion 130, providing further sealing material and/or adhesion between the components. Additionally, the side plate portion 132 covers and remains substantially flush with various portions of the sides (i.e., jambs) of the frame, which may include support materials 104, 108 (e.g., wall board, dry wall, siding, insulation material, foam). In some cases, the depth dₛ of the support material 104, 108 may be comparable to the depth dₗ of the lower corner flashing.

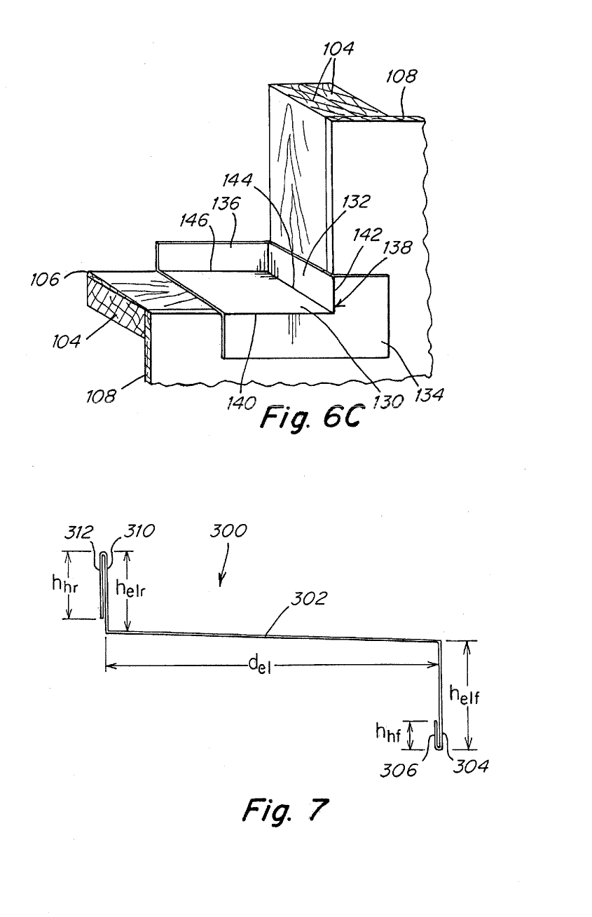

FIG. 7 depicts an illustrative embodiment of an elongated lower flashing 300 (e.g., sill pan flashing for placement over a window sill). The elongated lower flashing 300 includes an upward facing plate portion 302, a front plate portion 304, a hem 306 on the front plate portion, a rear plate portion 310 and a hook 312 on the rear plate portion.

Upon installation, the elongated lower flashing 300 may be placed over and engaged with each of the lower corner flashings 102a, 102b, effectively forming a continuous seal with the lower corner flashings over the lower region of the frame (e.g., over the entire window sill and upwards past the corners). The hook 312 on the rear plate portion 310 may be appropriately shaped to attach the elongated lower flashing 300 to each of the lower corner flashings 102a, 102b. That is, the respective rear plate portions 136 of each of the lower corner flashings 102a, 102b may be inserted into the slot provided by the hook 312 so as to form an attachment between the elongated lower flashing and each of the first and second lower corner flashings 102a, 102b. Accordingly, the flashings 102a, 102b, 300 form a continuous seal unit that extends fully between opposite sides of the frame and covering respective corners of the lower region of the frame.

Such a combination of flashings effectively prevents water from penetrating into sensitive areas of the frame and around the frame (e.g., at the corners and beyond), substantially limiting the possibility for water damage to occur. Though, it can be appreciated that other arrangements are possible for forming a unit similar to that described above for directing water flow in a desirable manner. For example, rather than three separate flashing components, a single continuous unit may be appropriately shaped to be functionally equivalent to the combined arrangement provided by the elongated lower flashing engaged with both of the lower corner flashings and may, thus, be appropriate for flashing the lower region of the frame (e.g., sill of a window or door). Such a continuous unit may be optionally provided in the flashing kit. For example, a continuous unit may effectively amount to an elongated lower flashing soldered and/or welded to respective lower corner flashings, or monolithically formed.

The hem 306 on the front plate portion 304 is an optional feature and may or may not be used for an attachment purpose. For example, rather than functioning as a hem, this component may be used as a hook that attaches to another structural feature. Though, despite whether the hem 306 may be attached to another structural feature, such a structure may be helpful to obstruct water from migrating under the front plate portion 304 and in a direction back toward the inside of the building/frame. Such a structure may also promote dripping of water off the bottom of the rounded area of the hook so as to drain in a suitable manner away from the building.

Various portions of the elongated lower flashing 300 may have any suitable dimensions. These dimensions may depend on the type of frame that requires flashing installation and its particular dimensions. For instance, FIG. 7 depicts an elongated lower flashing 300 having a depth dₑₗ of the elongated lower flashing, a height hₑₗᵣ of the rear plate portion 310, a height hₕᵣ of the hook 312 of the rear plate portion, a height h_{elf} of the front plate portion 304, and a height h_{hf} of the hem 306 of the front plate portion.

The depth dₑₗ of the elongated lower flashing may be comparable to the depth of an upward facing portion of the lower region of the frame (e.g., upper surface of a window sill). For example, a window sill may have a 2 inch×4 inch or 2 inch×6 inch construction where the depth is approximately 4 inches or 6 inches (or 3.5 inches or 5.5 inches), respectively. Accordingly, based on the distance between the front and rear edges of the opening, the depth dₑₗ may be long enough to suitably cover the upper side of the frame. In some embodiments, the depth dₑₗ of the elongated lower flashing may be between about 1 inch and about 12 inches, between about 2 inches and about 10 inches, between about 3 inches and about 6 inches (e.g., 3.5 inches, 4 inches, 5.5 inches), between about 5 inches and about 8 inches, or between about 6 inches and about 7 inches (e.g., 6 and ⅝ inches). Other dimensions of the depth dₑₗ of the elongated lower flashing are possible.

The height hₑₗᵣ of the rear plate portion 310 of the elongated lower flashing may complement the height hₗᵣ of the rear plate portion 136 of the lower corner flashings 102a, 102b so as to provide for suitable engagement, as shown in an example further below. In some embodiments, the height hₑₗᵣ of the rear plate portion 310 may be between about 0.5 inches and about 5 inches, between about 1 inch and about 3 inches, or between about 1 inch and about 2 inches (e.g., 1.5 inches). Other dimensions of the height hₑₗᵣ of the rear plate portion are also possible.

The height hₕᵣ of the hook 312 of the rear plate portion may be sufficient to form a suitable attachment between the elongated lower flashing and the lower corner flashings. For example, the height hₕᵣ may be small enough so that the hook 312 can be easily placed over the rear plate portions 136 of the lower corner flashings; and the height hₕᵣ may also be large enough so that a strong enough attachment is formed to substantially limit movement (e.g., front to rear and vice versa) between the elongated lower flashing and the lower corner flashings. In some embodiments, the height hₕᵣ of the hook 312 of the rear plate portion may be between about 0.5 inches and about 5 inches, between about 1 inch and about 3 inches, or between about 1 inch and about 2 inches (e.g., 1.25 inches). Other dimensions of the height hₕᵣ of the hook 312 of the rear plate portion are possible.

As discussed above, the hem 306 of the front plate portion 304 may be beneficial in providing a surface from which water may be more likely to drip than to migrate back into portions of the building structure (e.g., migration by capillary action). In some embodiments, the height h_{elf} of the front plate portion 304 may be between about 0.5 inches and about 5 inches, between about 1 inch and about 3 inches, or between about 1.5 inches and about 2.5 inches (e.g., 2 inches). In some embodiments, the height h_{hf} of the hem 306 of the front plate portion may be between about 0.1 inches and about 2 inches, between about 0.2 inches and about 1 inch, or between about 0.3 inches and about 0.7 inches (e.g., 0.5 inches).

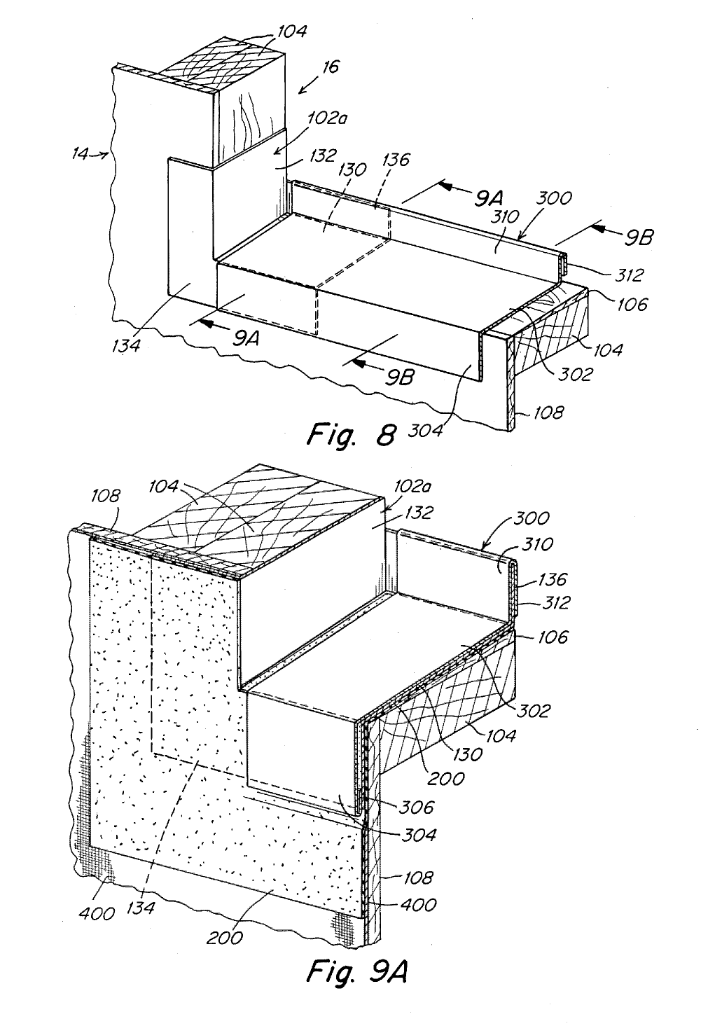

Also as mentioned above, the elongated lower flashing 300 may be engaged with each of the lower corner flashings 102a, 102b such that the elongated lower flashing effectively forms a continuous unit with the lower corner flashings that obstructs undesirable leakage of water in and around the lower region of the frame of the opening. FIG. 8 depicts a cut-away schematic of an embodiment where the hook 312 of the elongated lower flashing 300 is placed over the rear plate portion of the lower corner flashing 102a, attaching the flashings together. For the sake of simplicity, and to illustrate its optional nature, the hem 306 of the front plate portion is not shown.

FIG. 9A shows a cross-sectional view through a region where the hook 312 of an elongated lower flashing 300 is shown to be engaged with the rear plate portion 136 of a lower corner flashing 102a. As further shown in FIG. 9A, the elongated lower flashing 300 and the lower corner flashing 102a are placed over a protective strip 200 (e.g., flexible self-adhering membrane), which overlies a wedged member 106. FIG. 9B depicts a cross-sectional view through a central region of a flashed lower region where the lower corner flashings are not shown in the cross-section. At this part of the flashed lower region of the frame, the elongated lower flashing 300 may be in contact with the protective strip 200.

In some embodiments, a protective strip may be a self-adhering membrane provided as a flashing component to be integrated along with other elements of the overall building structure. A self-adhering membrane may provide for a suitable sealing, for example, as a rubber and/or bituminous based material. For instance, a self-adhering membrane may provide a rubberized asphalt adhesive sealing, or may include a polymer such as polyethylene, polypropylene, polyurethane, etc.

A number of other components for flashing a lower region of an opening are shown in FIG. 9B, which may be optionally included with the flashing kit. For example, a barrier material 400, such as an air barrier, may be attached to the front of a lower region of the frame of the opening. Air barriers may be useful, for example, in controlling leakage of air into and out of a building, and for providing insulation. Examples of suitable air barriers include, but are not limited to, building wraps (e.g., polyethylene-fiber, spun-bonded polyolefin, TYVEK®), self-adhering membranes (e.g., rubber, elastomer, with adhesive surfaces), fluid-applied membranes (e.g., paints, coatings, bitumen), spray-applied materials (e.g., polyurethane foams), support boards (e.g., dry wall, plywood, polystyrene), etc.

As depicted in FIG. 9B, the protective strip 200 may overlie a portion of the barrier material 400 so as to provide a suitable seal from water penetration. A building siding 402 may, in turn, be placed over the protective lower strip 200. In some embodiments, such a building siding 402 may be a clapboard, shingle, or other suitable material, which may be constructed to have a shape that promotes drainage of water toward the bottom of the building, rather than stagnation or collection of water in a manner that leads to damage.

Further, a layer 404 (e.g., made of felt or another suitable material) may be included, at least partially, over the protective strip 200 and the building siding 402. In some cases, the (felt) layer 404 may be useful for directing water to flow toward the exterior surface of the siding (e.g., shingle), and away from the building interior (e.g., voids between a siding and a portion of the frame of the opening) where water is more easily trapped and is able to pool.

A second building siding 406 may be placed over the (felt) layer 404. Similar to the building siding 402, the second building siding 406 may be a clapboard or shingle. Accordingly, a section of the layer 404 is sandwiched between portions of both sidings 402, 406. Such an arrangement draws water from the felt layer toward the outer surface of the building siding so as to appropriately drain.

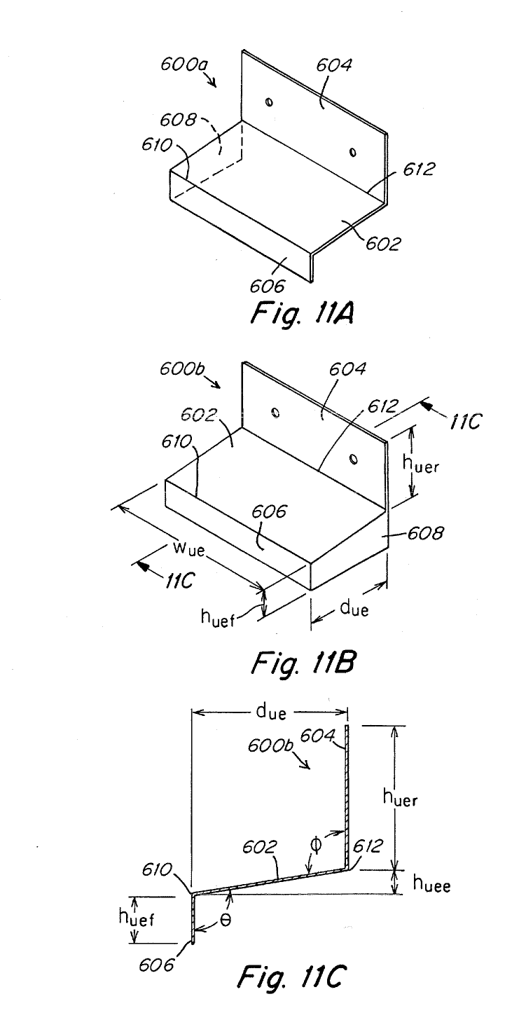

Once the lower region of the frame is appropriately flashed, other flashing components may be installed on the sides of the frame (e.g., window jambs). In some embodiments, a protective strip may be placed on a corresponding side of the frame, so as to provide an obstruction to water flow and accumulation through the sides of the frame. As an example, shown in FIG. 10, a protective strip 500 may be placed over certain portions of the lower corner flashing and over the elongated lower flashing. For instance, the protective strip placed on the side of the frame may cover, at least partially, the side plate portion 132 and the front plate portion 134 of a lower corner flashing, as well as part of the upward facing plate portion 302 of the elongated lower flashing 300. As shown, the protective strip 500 is cut so that one part of the strip is able to extend down past the surface of the sill and so that another part can be bent to extend horizontally and cover a portion of the elongated lower flashing. Such a cut of the protective strip 500 may be made prior to inclusion in the kit, or as part of the flashing installation process.

In some cases, a protective side strip may be a self-adhering membrane, or any other suitable material. For the sake of simplicity, the protective strip 200 and barrier material 400 are not shown in FIG. 10.

FIGS. 11A-11C depict examples of upper end cap flashings 600a, 600b (e.g., for placement over an upper/head trim board). In some embodiments, upper end cap flashings 600a, 600b include an upward facing plate portion 602, a rear plate portion 604, a front plate portion 606, and a side plate portion 608. Upper end cap flashings may be provided (e.g., in a pre-bent or molded configuration) as components in a flashing kit where each flashing has dimensions that are appropriate for flashing an opening of a building.

In some embodiments, upper end cap flashings may be placed so as to cover an upward facing portion of the frame, located over the opening (e.g., on an upper surface of a trim board positioned over the front of a window/door). In particular, upper end cap flashings may be placed on respective ends of the upper region of the frame (e.g., upper trim) so that the side plate portions of the flashings cover a side facing portion of the frame (e.g., side trim). For instance, the upper end cap flashing of FIG. 11A has a side plate portion 608 that is appropriate for placement of the flashing on one particular end of a upper trim (e.g., on the left-hand side of a trim board when viewing the frame from the front); whereas the side plate portion 608 of the upper end cap flashing shown in FIG. 11B is suitable for placement of the flashing on an opposite end of the upper trim (i.e., on the right-hand side of the trim board when viewing the frame from the front).

FIG. 11C illustrates a cross section of an upper end cap flashing showing the upward facing plate portion 602 connected to both the rear plate portion 604 and the front plate portion 606. It is advantageous for the upward facing plate portion 602 to be sloped downward toward the front of the upper end cap flashing, as shown, which, when appropriately installed, causes water to run from the rear plate portion to the front plate portion. Accordingly, as shown in FIG. 11C, the surface of the front plate portion 606 may form an angle θ with the surface of the upward facing plate portion 602 that is greater than 90 degrees (e.g., between about 90 degrees and about 100 degrees, between about 90 degrees and about 95 degrees). Similarly, in some embodiments, the surface of the rear plate portion 604 may form an angle φ with the surface of the upward facing plate portion 602 that is greater than 90 degrees (e.g., between about 90 degrees and about 100 degrees, between about 90 degrees and about 95 degrees). Also related, in some embodiments, the height h_{uce} between respective edges 610, 612 may be between about 0.01 inches and about 0.5 inches, between about 0.05 inches and about 0.3 inches, or between about 0.1 inch and about 0.2 inches (e.g., 0.125 inches).

Conventional metal for flashing upper regions of trim boards is typically composed of a light gauge metal (e.g., steel, aluminum), typically 18 mils (0.018 Al) or less. Such a light gauge results in the metal strip used for flashing to be bent backwards during transit, effectively forming a trough in which water will collect and subsequently flow out toward the side ends of the strip. This configuration of the flashing causes large volumes of water to cascade out the side ends of the flashing, causing more accumulation of water at sensitive areas of the frame/building. In some cases, such a situation can lead to even more water damage than if the conventional unit was never installed at all.

Accordingly, the upper end cap flashing will be stiff enough (e.g., have a relatively large thickness or be composed of a relatively rigid material) that is sufficient to maintain the above-mentioned slope of the upward facing plate portion downward toward the front of the upper end cap flashing. In other words, despite the stresses experienced during shipping, handling and/or installation, the angles θ and φ are maintained to be above 90 degrees. In some embodiments, the upper end cap flashing is made of a metal that is greater than 18 mils or, for example, between about 18 mils and about 500 mils, between about 20 mils and about 10 mils, between about 30 mils and about 60 mils (e.g., 32 mils, 40 mils, 50 mils, 60 mils). Other thicknesses of the upper end cap flashing are possible.

The upper end cap flashing 600 may have dimensions that are appropriate for flashing a frame of an opening. FIGS. 11A-11C illustrate various dimensions, such as a width wᵤₑ of the upper end cap flashing, a depth dᵤₑ of the upper end cap flashing, a height hᵤₑᵣ of the rear plate portion, a height h_{uef} of the front plate portion, and a height h_{uce} between respective edges 610, 612 of the upper end cap flashing.

The width wᵤₑ of the upper end cap flashing may be sufficient to support an elongated upper flashing, as discussed further below. In some embodiments, the width wᵤₑ of the upper end cap flashing may be between about 1 inch and about 12 inches, between about 2 inches and about 10 inches, between about 2 inches and about 7 inches, or between about 3 inches and about 5 inches (e.g., 3, inches, 4 inches, 5 inches). In some cases, the width wᵤₑ of the upper end cap flashing may have a length outside of these ranges.

The depth dᵤₑ of the upper end cap flashing may be appropriate to allow for placement of the upper end cap flashing on and covering an upward facing portion of the upper region of a frame (e.g., on the upper surface of a trim board). The depth dᵤₑ of the upper end cap flashing will depend largely on the thickness of the head trim board (e.g., 0.5 inches, 0.75 inches, 1 inch, 1.25 inches, 1.625 inches, etc.), as the upper end cap flashing will cover the head trim board from the front edge to the rear edge. For example, the depth dᵤₑ of the upper end cap flashing may be between about 0.1 inch and about 5 inches, between about 0.25 inches and about 3 inches, or between about 0.5 inches and about 2 inches (e.g., 0.75 inches, 1 inch, 1.5 inches). In some cases, the depth dᵤₑ of the upper end cap flashing may have a length outside of these ranges.

In some cases, the upper end cap flashing may be attached over an upper end of the trim (e.g., on a wall above the upper surface of a trim board) by any suitable method, such as for example, via an adhesive material, a number of suitable fasteners, or the like. For instance, the rear plate portion may include a number of holes for accommodating one or more fasteners and the height hᵤₑᵣ of the rear plate portion may be long enough to provide sufficient support for the fastener hole(s). Accordingly, the height hᵤₑᵣ of the rear plate portion may have any suitable dimension. In some embodiments, the length of the height hᵤₑᵣ of the rear plate portion is approximately the same as that of the depth dᵤₑ. In some embodiments, the height hᵤₑᵣ of the rear plate portion may be between about 0.1 inch and about 5 inches, between about 0.5 inches and about 3 inches, or between about 1 inch and about 2 inches (e.g., 1.5 inches). Or, the height hᵤₑᵣ of the rear plate portion may have a length outside of these ranges.

The height h_{uef} of the front plate portion may be a sufficient length so as to cover enough of the trim (e.g., front facing portion of an upper region of a trim board) so as to prevent water from leaking back into the frame or other sensitive regions of the building. In some embodiments, the front plate portion is structured (e.g., includes a curved or hooked portion similar to hem 306) to promote appropriate drainage. For example, the front plate portion may cause water to drip from the upper end cap flashing toward the ground rather than seep into and accumulate into surrounding building material. In some embodiments, the height h_{uef} of the front plate portion may be between about 0.1 inch and about 5 inches, between about 0.1 inch and about 2 inches, between about 0.25 inches and about 3 inches, or between about 0.4 inches and about 1 inch (e.g., 0.5 inches). The height h_{uef} of the front plate portion may have a length outside of these ranges.

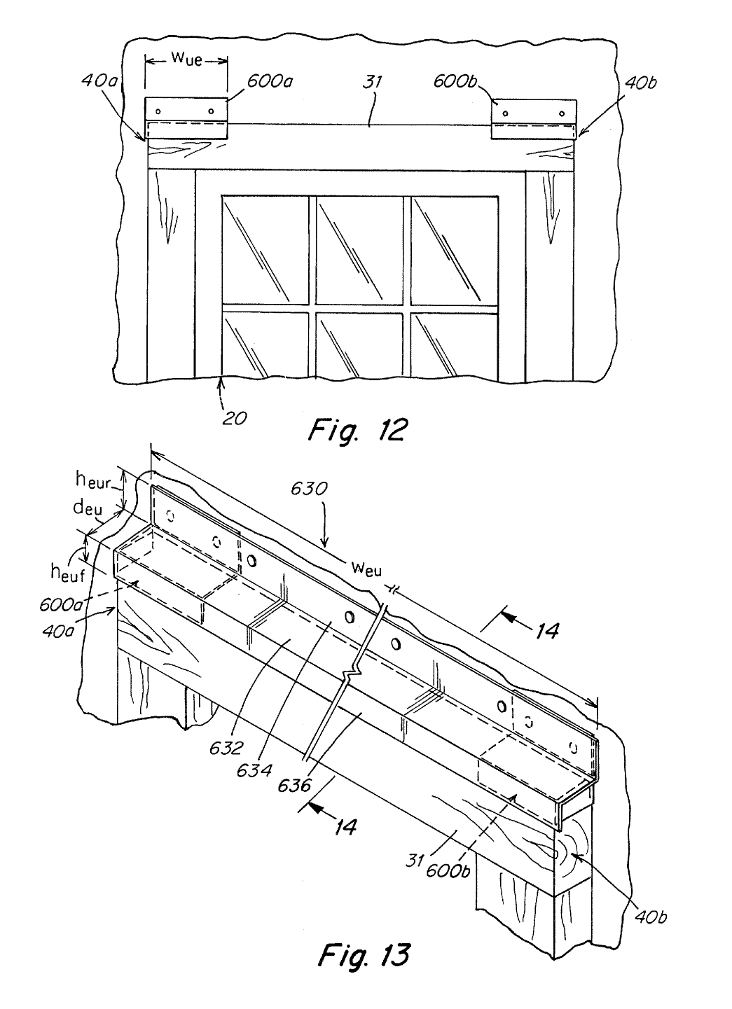

FIG. 12 shows an illustrative embodiment of upper end cap flashings 600a, 600b placed on opposing ends of an upward facing portion of a trim (e.g., on top of the trim board of a window or door frame). As shown, the side plate portions of each of the upper end cap flashings 600a, 600b extend downward from the upper surface of the trim and cover, at least partially, side facing portions 40a, 40b of the trim board, thus, providing protection of the frame from water. Accordingly, water flows off the side plate portions in a manner that does not result in accumulation of water in the material of the frame, which would enhance the likelihood of damage.

FIG. 13 depicts partial view of an illustrative embodiment of an elongated upper flashing 630. When installed, the elongated upper flashing 630 is placed over and extends between opposing upper end cap flashings 600a, 600b. In some embodiments, the elongated upper flashing 630 rests over the opposing upper end cap flashings 600a, 600b. In some embodiments, the elongated upper flashing 630 is attached to respective upper end cap flashings 600a, 600b (e.g., via an adhesive material, fasteners, etc.).

The elongated upper flashing 630 includes an upward facing plate portion 632, a rear plate portion 634 and a front plate portion 636. The elongated upper flashing 630 may have any suitable dimensions appropriate for flashing an upper region of a frame of an opening.

Similarly to the upper end cap flashings 600, the upward facing plate portion 632 of the elongated upper flashing 630 may be sloped downward toward the front plate portion so that water has a tendency to flow from the rear plate toward the front plate and off the flashing 630, preventing water accumulation and subsequent damage. In some embodiments, the surface of the rear plate portion 634 may form an angle with the surface of the upward facing plate portion 632 that is greater than 90 degrees (e.g., between about 90 degrees and about 100 degrees, between about 90 degrees and about 95 degrees). Similarly, the surface of the front plate portion 636 may form an angle with the surface of the upward facing plate portion 632 that is also greater than 90 degrees (e.g., between about 90 degrees and about 100 degrees, between about 90 degrees and about 95 degrees).

The width wₑᵤ of the elongated upper flashing may be long enough to extend over both upper end cap flashings 600a, 600b placed on either side of the upper surface of the trim. In some cases, the elongated upper flashing extends between opposite sides of a window. Or, the elongated upper flashing may extend entirely over the width of the upper surface of the trim (e.g., entire width of the top of the trim board). In some embodiments, the width wₑᵤ of elongated upper flashing may be between about 1 foot and about 15 feet, between about 2 feet and about 10 feet, between about 3 feet and about 5 feet (e.g., 4 feet), or between about 6 feet and about 9 feet (e.g., 8 feet). In some cases, the width wₑᵤ of elongated upper flashing may have a length outside of the above noted ranges.

The depth dₑᵤ of elongated upper flashing may be appropriate for placement of the elongated upper flashing on the upper trim (e.g., trim board of a window or door frame) and over each of the upper end cap flashings 600. For example, the depth dₑᵤ of the elongated upper flashing will depend, at least in part, on the thickness of the head trim board (e.g., 0.5 inches, 0.75 inches, 1 inch, 1.25 inches, 1.625 inches, etc) to accommodate different sizes/types of trim boards. In some cases, the depth dₑᵤ of the elongated upper flashing is comparable (e.g., approximately equal) to the depth dᵤₑ of the upper end cap flashings. It can be appreciated that these dimensions depend on the actual dimensions of the frame to be installed with suitable flashing. In some embodiments, the depth dₑᵤ of the elongated upper flashing may be between about 0.1 inch and about 10 inches, between about 0.25 inches and about 3 inches, or between about 0.5 inches and about 2 inches (e.g., ⅞ inches, 0.75 inches, 1 inch, 1.5 inches).

Similar to the upper end cap flashings, the elongated upper flashing may be attached over the upper trim (e.g., on a wall above the upper surface of a trim board) by any suitable method (e.g., adhesive, fasteners). FIG. 12 depicts a number of suitable attachment points for the elongated upper flashing against the region of the frame just above the trim. For example, the rear plate portion may include a number of holes for accommodating fasteners at appropriate locations.

The height hₑᵤᵣ of the rear plate portion 634 may be any suitable dimension. For example, this height hₑᵤᵣ may complement the respective height hᵤₑᵣ of the rear plate portions 604 of the upper end cap flashings 600. In some embodiments, the height hₑᵤᵣ may be approximately the same as the height hᵤₑᵣ of the respective end caps. For example, the height hₑᵤᵣ of the rear plate portion 634 may be between about 0.1 inch and about 5 inches, between about 0.5 inches and about 3 inches, or between about 1 inch and about 2 inches (e.g., 1.5 inches).

The height h_{euf} of the front plate portion of the elongated upper flashing 630 may similarly complement the height h_{uef} of the front plate portion of the upper end cap flashings 600a, 600b, for preventing water accumulation in sensitive areas and subsequent damage. In some embodiments, the height h_{euf} of the front plate portion may be between about 0.1 inch and about 5 inches, between about 0.1 inch and about 2 inches, between about 0.25 inches and about 3 inches, or between about 0.4 inches and about 1 inch (e.g., 0.5 inches).

The elongated upper flashing 630 may reside over and/or be attached to each of the opposing upper end cap flashings 600. In some embodiments, the elongated upper flashing 630 is fastened or adhered to the upper end cap flashings 600. For instance, one or more adhesive/sealing materials (e.g., adhesive strip, caulk, sealant) may be provided in between the elongated upper flashing and the upper end cap flashings. In other embodiments, the elongated upper flashing 630 simply rests on the upper end cap flashings 600a, 600b without further joining or attachment.

This combination of upper flashings may be effective to prevent water from leaking into sensitive areas of the frame and around the frame of the building. Similar to that with respect to the lower flashings, other arrangements are also possible, such as a single continuous unit that is shaped to suitably flash the upper region of the frame (e.g., head trim board). This continuous unit may optionally be provided in the flashing kit. For instance, such a continuous unit may include an elongated upper flashing soldered and/or welded to respective upper end cap flashings, or monolithically formed.

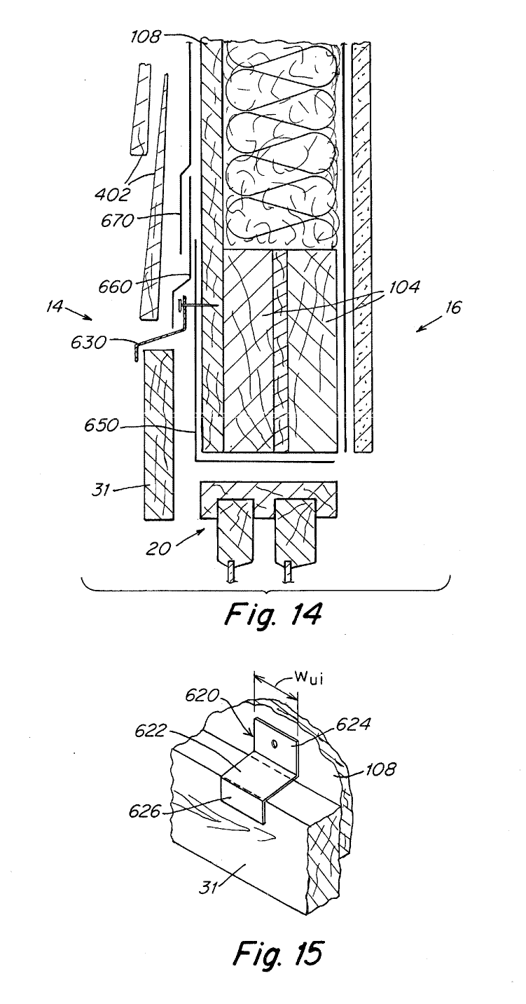

FIG. 14 depicts a cross-sectional view through the middle of an embodiment of an elongated upper flashing 630 installed on an upper trim of the frame of an opening (e.g., in window/door head). The elongated upper flashing 630 may be provided in any appropriate dimensions that accommodate different types of trim boards (e.g., head trim boards having thicknesses of 0.5 inches, 0.75 inches, 1 inch, 1.25 inches, 1.625 inches, etc.) As shown, the elongated upper flashing and other protective strips are arranged in a layered configuration so that water flows toward the front of the building in a generally outward direction from the opening and is prevented from detrimentally accumulating. In other words, by the arrangement shown, water flowing downward by the force of gravity is substantially prevented from being trapped or collecting at various regions of the frame or other parts of the building that would otherwise lead to water damage. It can be appreciated that other arrangements may also be possible.

FIG. 14 further shows, as part of the frame of the opening, a trim board 31 (e.g., ¾ inch window trim board) positioned over an inner protective strip 650. While not shown in this middle cross-sectional view, the upper end cap flashings are placed on opposite ends of the trim board 31, supporting the elongated upper flashing 630. The elongated upper flashing 630, in combination with the upper end cap flashings on opposing ends, provides a surface on which water runs over and toward the front, away from the building. As shown, the elongated upper flashing is fastened to the support material 108 of the frame.

As further shown in FIG. 14, a first outer protective strip 660 is placed over the support material 108 of the frame, the inner protective strip 650 and the elongated upper flashing 630. The inner protective strip 650 is disposed between the first outer protective strip 660 and the support material 108 so as to provide for a suitable sealing. The first outer protective strip 660 may include any appropriate material, for example, a self-adhering membrane, elastomer, sealing material, plastic, etc. A second outer protective strip 670 may be placed over the first outer protective strip 660. The second outer protective strip 670 may be any suitable layering material, for example, an air barrier, building wrap, membrane, or the like. As a result, water runs over the outside of the second outer protective strip 670, over the first outer protective strip 660, and then over the elongated upper flashing 630, eventually flowing off from the front of the frame.

In some embodiments, particularly for longer openings (e.g., windows 8 feet or greater in width), it may be beneficial to include one or more additional upper flashings between the upper end cap flashings. FIG. 15 shows an embodiment of an upper intermediate flashing 620 placed over a trim board 31 in between the upper end cap flashings. The upper intermediate flashing 620 includes an upward facing plate portion 622, a rear plate portion 624 and a front plate portion 626, each of the plate portions having appropriate dimensions depending on the opening to be flashed. For example, the width wᵤᵢ of the upper intermediate flashing may be between about 0.1 inch and about 10 inches, between about 0.5 inches and about 8 inches, or between about 1 inches and about 5 inches (e.g., 2 inches, 3 inches). The width wᵤᵢ of the upper intermediate flashing may vary according to the size of the window. For example, the larger the window opening, the longer the width wᵤᵢ of the upper intermediate flashing may be. The depth of the upper intermediate flashing may be suitable to accommodate any sized head trim board.

Generally, flashings described herein, such as, lower corner flashings, elongated lower flashings, upper end cap flashings, elongated upper flashings, upper intermediate flashings, may be composed of any suitable material that can substantially hold its shape while subject to externally applied stresses, such as a rigid material. Accordingly, in some cases, flashings may include an appropriate plastic (e.g., rigid molded polymer) or metal (e.g., aluminum, copper, painted galvanized steel, stainless steel, zinc alloy, etc.).

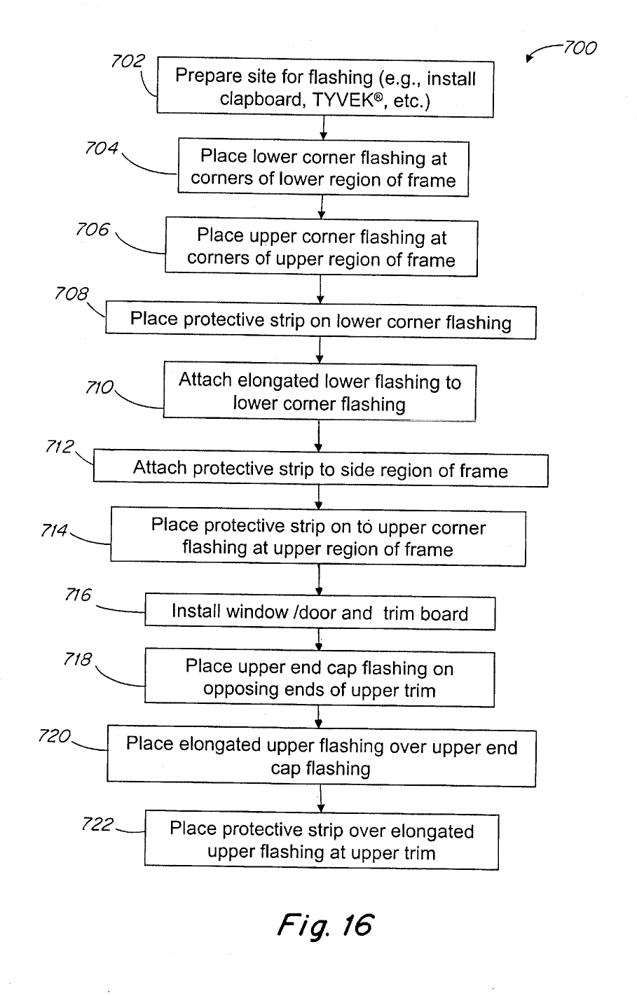

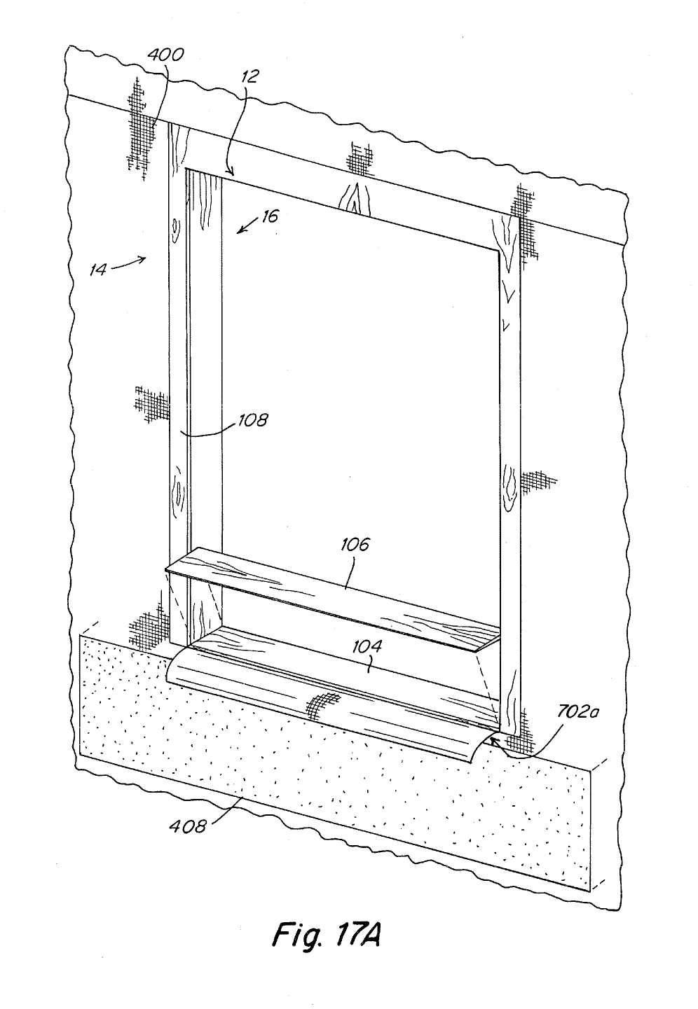

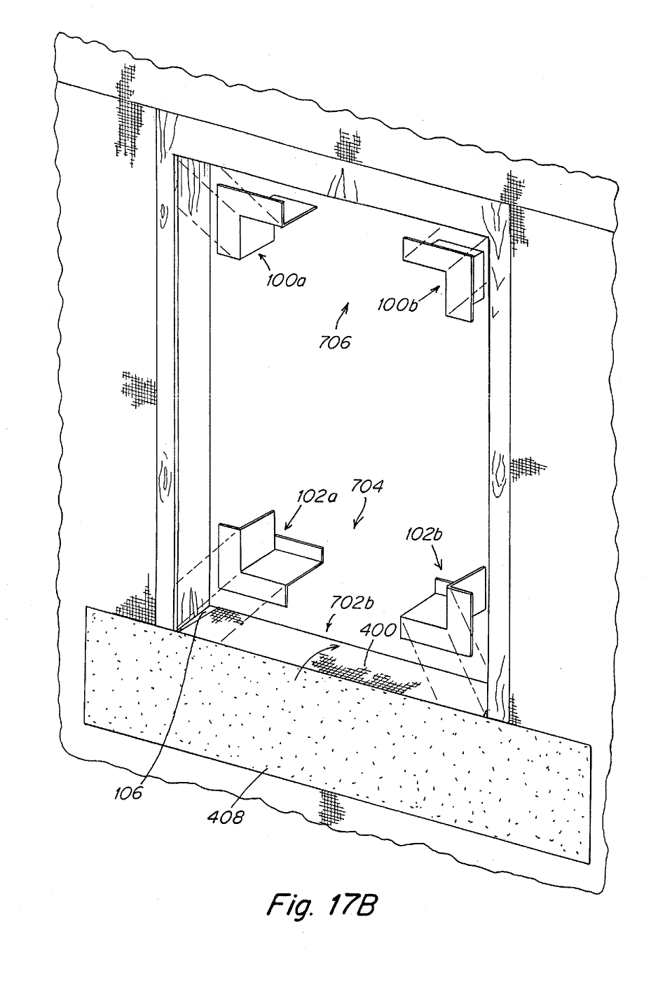

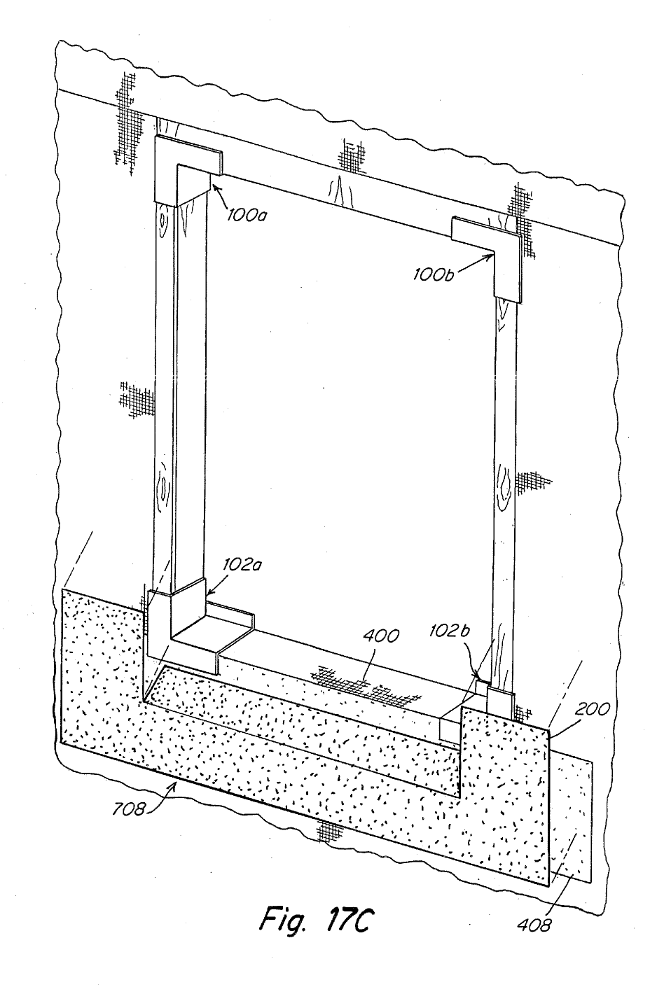

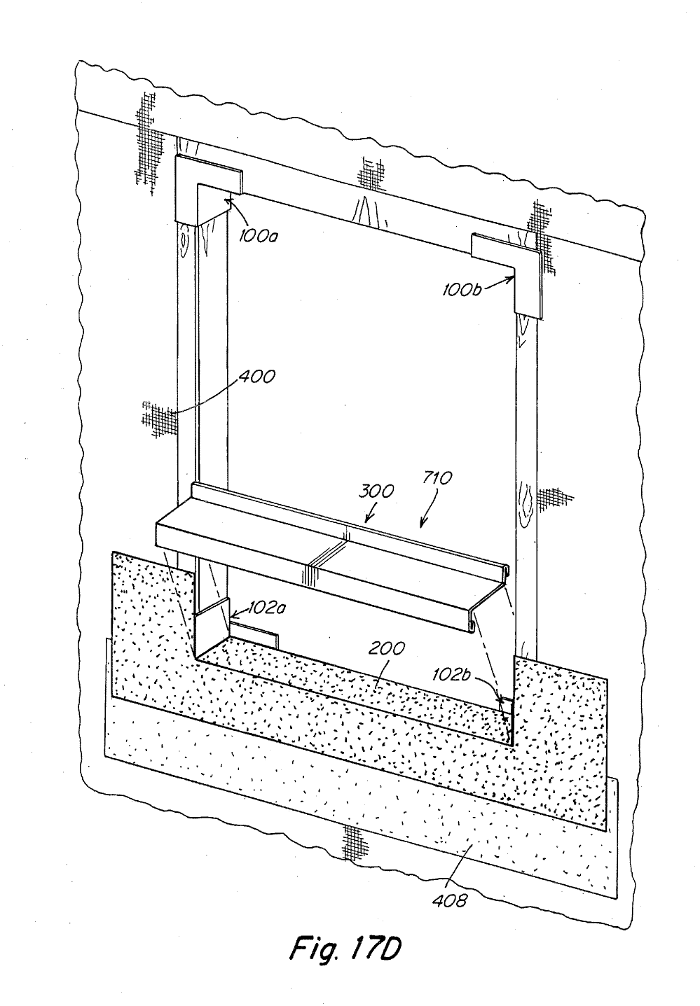

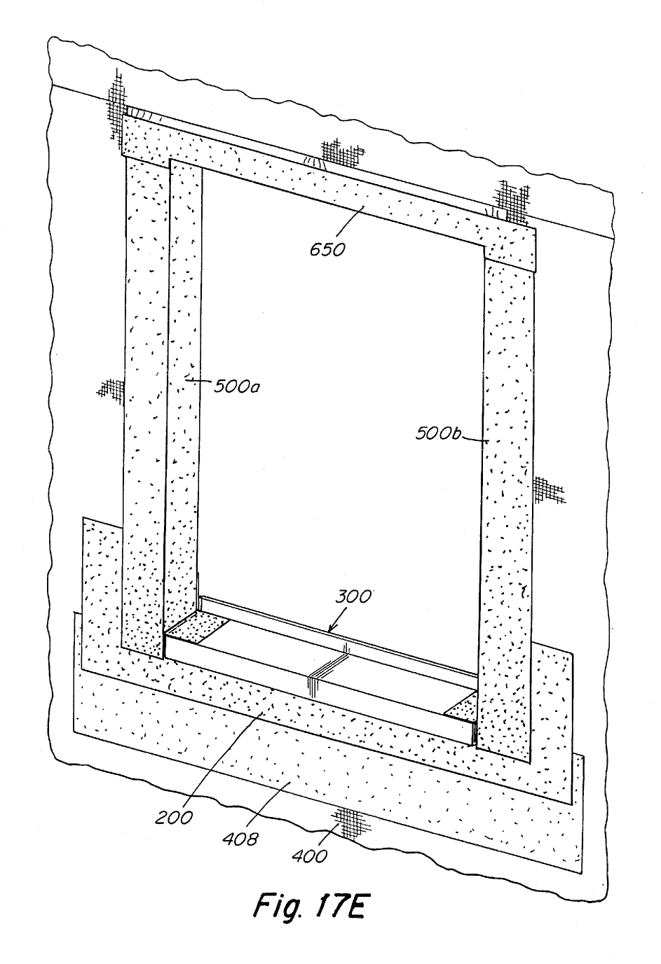

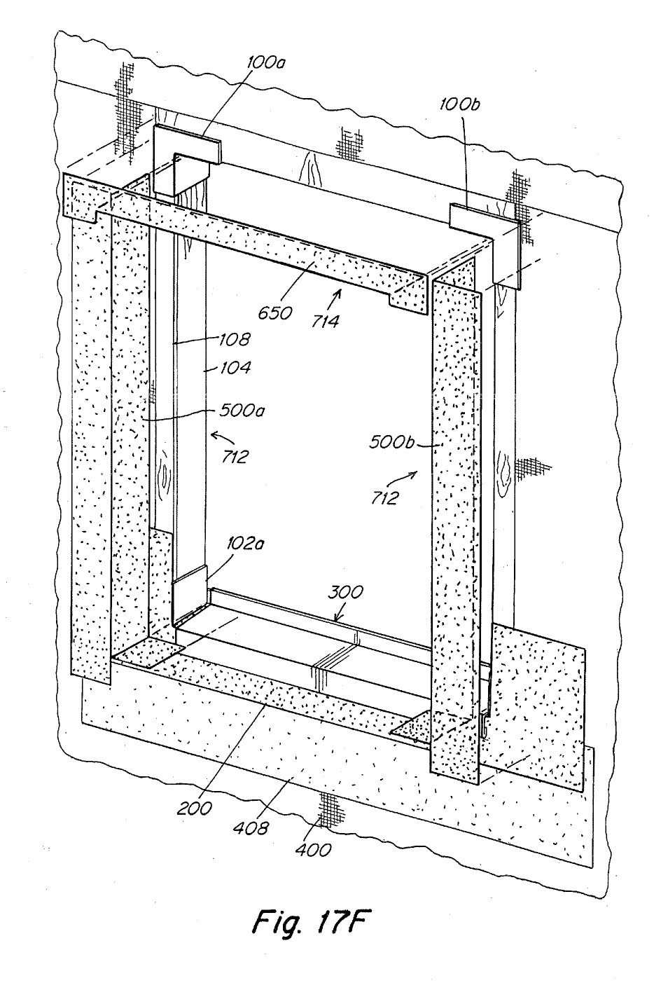

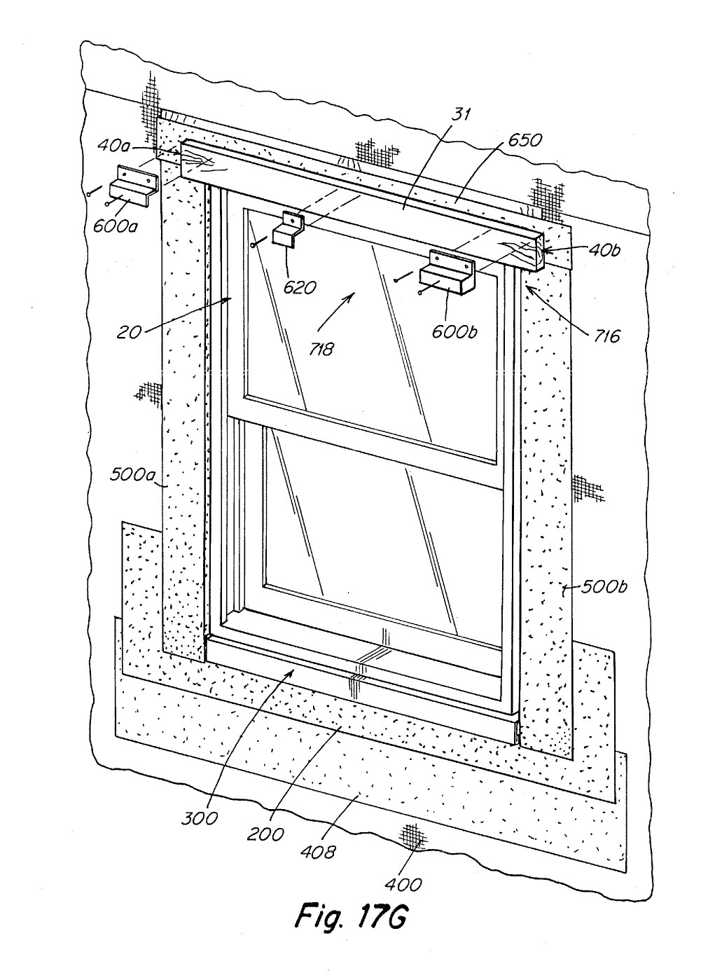

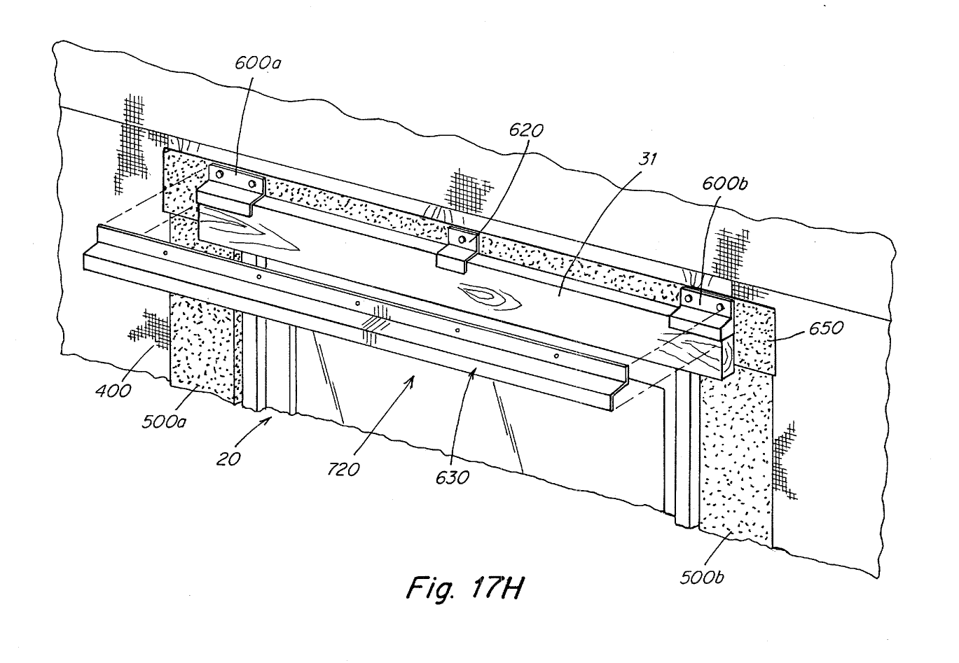

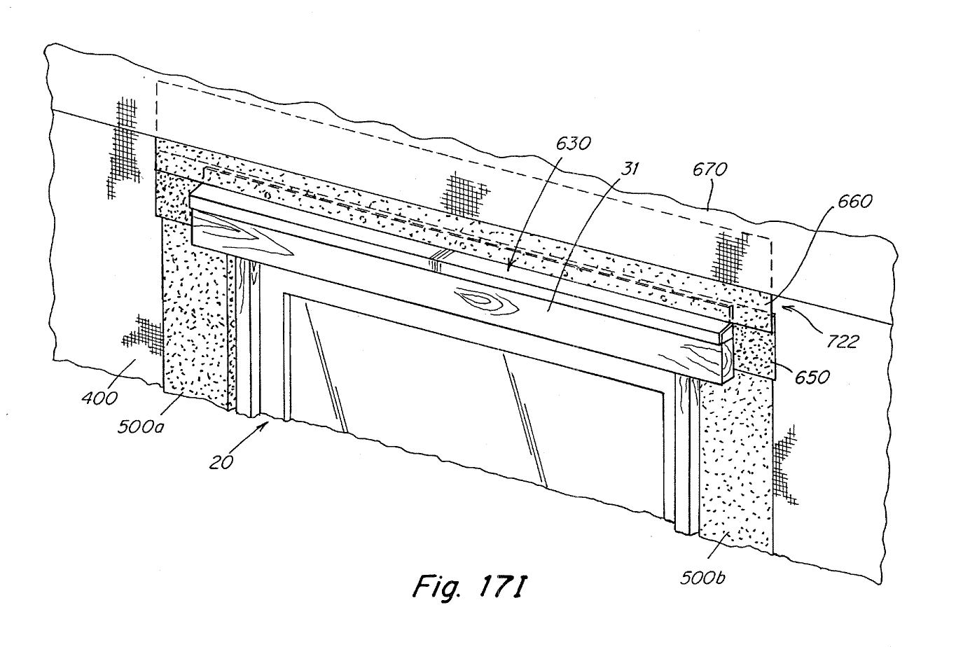

A flow diagram showing a number of exemplary steps 700 for properly installing the components included within a kit for flashing an opening is provided in FIG. 16. FIGS. 17A-17I depict various steps in some embodiments for installing appropriate flashing components on various regions of a window frame, e.g., the window sill, jambs and head. In some embodiments, the instructions that come with the kit correspond to the method steps described herein, or in some cases, a subset of the method steps. For instance, the kit may include a description of such steps with associated illustrations for instructing a worker how to easily install the flashing components. It can be appreciated that this method is presented for illustrative purposes and that methods other than those described herein for properly installing flashing components may be used.

In step 702, the site of the opening is prepared for flashing. In the example shown in step 702a of FIG. 17A, a building wrap (e.g., TYVEK®), which is useful as an air barrier, is applied (e.g., adhered) to the front of the window frame at a region below the surface of the sill and is appropriately cut so that a portion of the building wrap folds into the window opening. A felt layer 408 is applied (e.g., adhered) over the building wrap in front of the window frame at the same region below the surface of the sill. Though, in this example, while not required, the felt layer remains below the sill while the building wrap extends further up and folds into the opening.

Building siding may be placed around the window frame, such as siding shown in FIG. 9B. In some embodiments, a portion of the felt layer is sandwiched between two pieces of building siding adjacent to the window sill. While building siding is not expressly shown in FIGS. 17A-17I, an upper portion of a first piece of building siding (e.g., siding 402 in FIG. 9B) may be tucked underneath the felt layer. Later, a second piece of building siding (e.g., siding 406 in FIG. 9B) may be installed so that a portion of the felt layer is kept in between the two pieces of building siding. That is, a section of the felt layer covers an upper portion of the first piece of building siding and is, in turn, covered by a lower portion of the second piece of building siding. As such, the felt layer, in this position, guides water toward the building exterior (e.g., siding). Accordingly, this arrangement of the felt layer disposed in between two pieces of building siding and adjacent the window sill may promote drainage of water away from the wall assembly (where water might otherwise accumulate) and down the siding material.

Further, the wedged member (e.g., clapboard) 106 is placed on the upper surface of the window sill such that the upper surface of the wedged member is sloped downward toward the front of the opening. Once the wedged member is in place, as shown in step 702b of FIG. 17B, the portion of the building wrap that folds into the opening is placed over the wedged member.

In step 704, the lower corner flashings are placed at respective corners of the lower region of the frame of the opening. For instance, FIG. 17C shows lower corner flashings placed at corresponding corners of the window sill.

As the lower corner flashings are installed at the bottom corners of the frame, in step 706, the upper corner flashings are also placed at respective corners at the top of the window frame.

In step 708, the portion of the protective strip 200 that extends into the opening of the frame is placed over the lower corner flashings. As shown in FIG. 17D, a self-adhering membrane is cut so that a portion folds appropriately into the opening of the window frame, similarly to the previously installed building wrap. Accordingly, that portion of the self-adhering membrane that folds into the opening of the window frame contacts both the lower corner flashings and the wedged member (or the barrier placed over the wedged member). In addition, portions of the self-adhering membrane extend from the opening and remain attached over the front surface of the frame below and to the side of the window sill. The protective lower strip may include any suitable dimensions. For example, for flashing a standard-sized residential window, the protective lower strip may be a 12 inch×36 inch strip of self-adhering membrane.

In step 710, an elongated lower flashing is appropriately attached to the lower corner flashings. For example, a hook on the rear plate portion of the elongated lower flashing engages with the rear plate portion of each of the lower corner flashings so that an appropriate attachment is formed. Such an attachment substantially limits movement of the elongated lower flashing and lower corner flashings relative to one another (particularly from front to rear and vice versa) effectively forming a continuous unit that obstructs water penetration into the frame and/or other parts of the building.

After flashing components are suitably installed at the lower region of the window frame, or window sill, the flashing installation can proceed to other portions of the frame. For instance, in step 712, shown in FIG. 17E, protective strips may be placed on corresponding side regions of the frame. As discussed previously, bottom portions of the protective strips 500 may be cut, prior to or during installation, so that part of the strip can run horizontally over a relatively small portion of the elongated lower flashing 300. For example, self-adhering membranes may be placed on the window jambs, which extend from the window head down past the horizontal surface of the window sill. The protective strip may include any suitable dimensions. For example, for flashing a standard-sized residential window, the protective strip may be a 12 inch×60 inch strip of self-adhering membrane. After the protective strips are installed, the upper region of the frame is ready to be flashed.

In step 714, inner protective strip 650 is placed on the upper corner flashings, which are already installed at the upper region of the frame (e.g., window head). As a result, the front of the upper corner flashings 100a, 100b are substantially covered by the inner protective strip 650, as shown in FIG. 17F. The protective strip may include any suitable dimensions. For example, for flashing a standard-sized residential window, a protective strip may be a 12 inch×36 inch strip of self-adhering membrane. In some embodiments, one or more of the protective strips may be a relatively rigid material, such as a metal or plastic.

Subsequently, in step 716, shown in FIG. 17G, the opening of the frame is installed/filled, for example, with a window, glazing and/or door piece 20. If not already attached to the frame, a trim board 31 is attached as a part of the frame bordering the window, glazing and/or door piece.

In step 718, upper end cap flashings 600a, 600b are placed on opposing ends to cover an upper surface of the trim 31. The upper end cap flashings are rigid enough so that each of the upward facing plate portions is maintained to exhibit a downward slope toward the front of the frame. Each of the upper end cap flashings have a side plate portion that, when installed, covers side facing portions 40a, 40b of the trim 31. Upper intermediate flashing 620 may be installed with the upper end cap flashings. More upper flashing components may be installed on the upper surface of the trim.

Once the upper end cap flashings 600a, 600b and one or more optional upper intermediate flashings 620 of suitable size are appropriately situated (depending on the window size), in accordance with step 720, shown in FIG. 1711, the elongated upper flashing 630 is placed over and optionally attached on each of the upward facing plate portions of the upper end cap flashings and/or upper intermediate flashing. In some embodiments, the width of the elongated upper flashing is substantially equal to the width of the upper surface of the trim board. Once the elongated upper flashing is appropriately positioned, the arrangement causes water to flow toward the front of the frame rather than flowing back into a ditch-like space and cascading off the sides of the frame.

In step 722, shown in FIG. 17I, one or more outer protective strips 660, 670 are placed over and may be attached to a portion of the elongated upper flashing 630, contributing to the layered arrangement for promoting favorable drainage. The outer protective strip(s) 660, 670 may include any suitable dimensions. For example, for flashing a standard-sized residential window, an outer protective strip may be a 4 inch×48 inch strip of self-adhering membrane, or any other suitable material.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

Having thus described several aspects of at least one embodiment of this invention, it is to be appreciated various alterations, modifications, and improvements will readily occur to those skilled in the art. Such alterations, modification, and improvements are intended to be part of this disclosure, and are intended to be within the spirit and scope of the invention. Accordingly, the foregoing description and drawings are by way of example only.

What is claimed is:

1. A kit including instructions for installing flashing components on a frame for protecting a building structure, the kit comprising:
at least one protective strip constructed to be placed at a lower region of the frame;
at least one lower flashing constructed to be placed at the lower region of the frame;
at least one protective strip constructed to be placed at a side region of the frame;
at least one protective strip constructed to be placed at an upper region of the frame;
at least one upper flashing constructed to be placed at the upper region of the frame; and
a container for holding each of the at least one protective strip constructed to be placed at the lower region, the side region and the upper region of the frame, the at least one lower flashing, and the at least one upper flashing.

2. The kit of claim 1, wherein the at least one lower flashing comprises a lower corner flashing constructed to be placed at a corner of the lower region of the frame and having a rear plate portion constructed to extend along a rear portion of the lower region of the frame and substantially parallel to a plane defined by the frame.

3. The kit of claim 2, wherein the at least one lower flashing further comprises an elongated lower flashing constructed to be attached to the rear plate portion of the lower corner flashing.

4. The kit of claim 3, wherein the elongated lower flashing includes a rear plate portion comprising a hook for engaging with the lower corner flashing.

5. The kit of claim 1, wherein the at least one lower flashing comprises a first lower corner flashing and a second lower corner flashing each constructed to be placed at respective corners of the lower region of the frame and each having a rear plate portion adapted to engage with an elongated lower flashing connecting the first and second lower corner flashings together.

6. The kit of claim 1, wherein the at least one lower flashing comprises a rigid material including plastic or metal.

7. The kit of claim 1, wherein the at least one upper flashing comprises a head end cap flashing constructed to be placed at an end of the upper region of the frame and having a side plate portion adapted to cover a side facing portion of the upper region of the frame.

8. The kit of claim 7, wherein the at least one upper flashing comprises an elongated upper flashing constructed to be placed on the upper end cap flashing.

9. The kit of claim 1, wherein the at least one upper flashing comprises an upper end cap flashing including an upward facing plate portion adapted to cover an upward facing portion of the upper region of the frame, the upward facing plate portion having a surface sloped downward toward a front of the frame.

10. The kit of claim 1, wherein the at least one upper flashing comprises a side plate portion adapted to cover a side facing portion of the upper region of the frame.

11. The kit of claim 1, wherein the at least one upper flashing comprises a rigid material including plastic or metal.

12. The kit of claim 1, wherein the at least one protective strip comprises a self-adhering membrane.

13. The kit of claim 1, wherein the at least one protective strip comprises a wedged member having a sloped upper surface.

14. A component for placement at a lower region of a frame providing protection for a building structure, the component comprising:
a lower corner flashing including a rear plate portion constructed to extend along a rear portion of the lower region of the frame and substantially parallel to a plane defined by the frame, the rear plate portion further constructed to engage with a portion of an elongated lower flashing so as to limit movement between the lower corner flashing and the elongated lower flashing.

15. The component of claim 14, further comprising a side plate portion adapted to cover a portion of a side region of a frame.

16. The component of claim 14, further comprising an upward facing plate portion adapted to cover an upward facing portion of the lower region of the frame.

17. The component of claim 14, further comprising a front plate portion adapted to cover a front portion of the lower region of the frame.

18-22. (canceled)

23. A component for placement at an upper region of a frame providing protection for a building structure, the component comprising:
an upper end cap flashing including:
an upward facing plate portion having a surface maintained to be sloped downward toward a front of the frame and constructed to cover an end of an upward facing portion of the upper region of the frame; and
a side plate portion constructed to cover a side facing portion of the upper region of the frame.

24-25. (canceled)

26. The component of claim 23, wherein the upper end cap flashing comprises a front plate portion attached to the upward facing plate portion and the side plate portion.

27-28. (canceled)

29. The component of claim 23, wherein the upper end cap flashing comprises a rear plate portion attached to the upward facing plate portion.

30-54. (canceled)
